(19) United States
(12) Patent Application Publication
(10) Pub. No.: US 2025/0342226 A1
(43) Pub. Date: Nov. 6, 2025

(54) NOISE REDUCTION FOR MIXED IN-MEMORY COMPUTING

(71) Applicant: OmniVision Technologies, Inc., Santa Clara, CA (US)

(72) Inventors: Daisuke Saito, Santa Clara, CA (US); Andreas Suess, San Jose, CA (US)

(21) Appl. No.: 18/988,672

(22) Filed: Dec. 19, 2024

Related U.S. Application Data
(60) Provisional application No. 63/642,511, filed on May 3, 2024.
(60) Provisional application No. 63/642,533, filed on May 3, 2024.

(51) Int. Cl. G06F 17/16; G06F 7/523

(52) U.S. Cl. CPC G06F 17/16; G06F 7/523

(57) ABSTRACT

A mixed analog/digital in-memory computing device implements matrix vector multiplication with reduced noise for use by a deep neural network (DNN). For each row of a cross-bar array a digital multiplier is split into a least significant (LS) portion and a most significant (MS) portion of different sizes that are preloaded into two cells on one row and two different columns of the cross-bar array. An input activation (IA) value is driven onto input conductors of each row and an analog-to-digital converter (ADC) converts output signals from the two columns as a MS partial sum and a LS partial sum. A gain is applied to the MS partial sum and added to the LS partial sum to form a resulting value for one node of the DNN.

### RELATED APPLICATIONS

This application claims priority to U.S. Provisional Patent Application Ser. No. 63/642,511, titled “Noise Reduction for Mixed In-Memory Computing”, filed May 3, 2024, and to U.S. Provisional Patent Application Ser. No. 63/642,533, titled “Noise Reduction for Mixed In-Memory Computing”, filed May 3, 2024, each of which is incorporated herein by reference.

### BACKGROUND

Deep neural networks (DNN) require large amounts of memory, where data is read from the memory, processed, and then stored in the memory. This bottleneck between digital memory and a processing unit is well known for computers using the von Neumann architecture. Over 60% of power and time for a DNN computational problem is spent moving data between the memory and the processing unit-more than the power and time spent processing the data.

In-memory computing is emerging as one way of overcoming this bottleneck, particularly for DNN acceleration. Breaking the memory wall is seen as a way to enable massive computational parallelism for use by DNN. The use of alternative memory devices, such as the memristor, offer further advantages to DNN.

### SUMMARY

The present embodiments include the realization that while analog in-memory computing (AIMC) offers an efficient solution for a first stage of a deep neural networks (DNN), AIMC has a lower signal-to-noise ratio (SNR) as compared to digital solutions. The present embodiments provide mixed analog/digital in-memory computing with improved SNR of AIMC and thereby allow the advantages of AIMC to be realized for use in DNNs.

In certain embodiments, the techniques described herein relate to a noise reduction method for mixed in-memory computing implemented as a cross-bar array of analog cells, where each row of analog cells is connected to one of a plurality of input conductors and each column of analog cells is connected to one of a plurality of output conductors, the cross-bar array performing matrix vector multiplication, the method including: for each row of the cross-bar array: dividing a digital multiplier into at least a most significant (MS) portion and a least significant (LS) portion, the LS portion having more bits of the digital multiplier than the MS portion; preloading a first cell of a first column of a first row of the cross-bar array with a first analog signal representative of the MS portion right padded with zeros to have the same number of bits as the LS portion; preloading a second cell of a second column of the first row of the cross-bar array with a second analog signal representative of the LS portion; and driving one of the plurality of input conductors of the first row with an analog input signal representing a multi-bit input activation (IA) value for the first row; capturing an MS partial sum from the first column; capturing an LS partial sum from the second column; multiplying the MS partial sum by a scaling factor based on a number of bits in the LS portion; and adding the LS partial sum and the MS partial sum to form a resulting value.

In certain embodiments, the techniques described herein relate to a noise reduction method for mixed in-memory computing implemented as a cross-bar array of analog cells, where each row of analog cells is connected to one of a plurality of input conductors and each column of analog cells is connected to one of a plurality of output conductors, the cross-bar array performing matrix vector multiplication, the method including: for each row of a cross-bar array of analog cells: dividing a digital multiplier into at least a most significant (MS) portion and a least significant (LS) portion, the LS portion having more bits of the digital multiplier than the MS portion; preloading a first cell of a first column of a first row of a cross-bar array of analog cells with a first analog signal representative of the MS portion right padded with zeros to have the same number of bits as the LS portion; preloading a second cell of a second column of the first row of the cross-bar array with a second analog signal representative of the LS portion; slicing a digital input activation (IA) value of the first row into IA bits; and for each IA bit: driving an input conductor of the first row with a first reference voltage when the IA bit is zero and driving the input conductor with a second reference voltage when the IA bit is one; capturing an MS output signal from the first column as an MS partial sum; capturing an LS output signal from the second column as an LS partial sum; multiplying the MS partial sum by a first scaling factor based on a number of bits in the LS portion and a bit position of the IA bit; multiplying the LS partial sum by a second scaling factor based on the bit position of the IA bit; and storing the MS partial sum and the LS partial sum in memory of a logic operation unit; and adding, by the logic operation unit for each IA bit, the LS partial sums and the MS partial sums for each IA bit to form a resulting value.

In certain embodiments, the techniques described herein relate to a mixed analog/digital in-memory computing system with noise reduction, including: a cross-bar array of analog cells for performing matrix vector multiplication, the cross-bar array having a plurality of input conductors for each row of the cross-bar array, and a plurality of output conductors for each column of the cross-bar array; an input peripheral circuit for converting, for each row, an input activation (IA) value into an IA analog signal driving the input conductor of the row; an output peripheral circuit having: an analog-to-digital conversion circuit for converting, for each column, an output signal carried by the output conductor of the column to a digital value; and a logic operation unit for multiplying, adding, and storing the digital values from the plurality of columns; and control circuitry for controlling operation of the input peripheral circuit and the output peripheral circuit to cause the cross-bar array to perform matrix vector multiplication by splitting the digital multiplier between multiple columns and combining digital values from the multiple columns to form a resulting value with reduced noise.

### BRIEF DESCRIPTION OF THE FIGURES

FIG. 1 is a schematic of a prior art computing system implementing the von Neumann architecture to process image data captured by an image sensor.

FIG. 2 is a schematic of one example analog in-memory computation (AIMC) system for processing image data from an image sensor, in embodiments.

FIG. 3 is a schematic illustrating one example deep neural network (DNN) for processing the image data of FIG. 2 to generate an inference, in embodiments.

FIG. 4 is a schematic illustrating one example computational memory that performs matrix vector multiplication (MVM), in embodiments.

FIG. 5 is a schematic illustrating one example computational memory implemented in a current-domain technology, in embodiments.

FIG. 6 is a schematic illustrating example DRAM circuits that implement the cells of FIG. 4 in a charge-domain, in embodiments.

FIGS. 7A and 7B illustrate example operation of analog-to-digital converters (ADCs) for capturing values from the output conductors of FIG. 4, in embodiments.

FIG. 8 is a schematic illustrating splitting of a digital weight between two cells of the computational memory of FIG. 4 to increase a bit-width of the computational memory for an eight-bit input activation, in embodiments.

FIG. 9 is a schematic illustrating splitting of a digital weight between two cells of the computational memory of FIG. 4 to increase a bit-width of the computational memory for bit-sliced input activation (IA), in embodiments.

FIG. 10 is a schematic illustrating one example current-domain computational memory with improved noise reduction and increased SQNR, in embodiments.

FIG. 11 is a schematic diagram illustrating example operation of the computational memory of FIG. 10 with noise reduction for multi-bit IA values, in embodiments.

FIG. 12 is a flowchart illustrating one example noise reduction method for mixed in-memory computing, in embodiments.

FIG. 13 is a schematic diagram illustrating example operation of the computational memory of FIG. 10 with noise reduction when IA values are bit-sliced, in embodiments.

FIG. 14 is a flowchart illustrating one example noise reduction method for mixed in-memory computing with IA bit-slicing, in embodiments.

FIG. 15 shows one example implementation of the computational memory of FIG. 10 with the noise reduction of FIG. 13 when IA values are bit-sliced and where MS shifting, 1-bit shifting, and total summing are performed in the logic operation unit, in embodiments.

FIG. 16 shows one example implementation of the computational memory of FIG. 10 with the noise reduction of FIG. 13 when IA values are bit-sliced, where MS shifting is performed by the variable analog gain module, and where 1-bit shifting and final summing are performed in the logic operation unit, in embodiments.

FIG. 17 shows one example implementation of the computational memory of FIG. 10 with the noise reduction of FIG. 13 when IA values are bit-sliced, where 1-bit shifting is performed by the variable analog gain module, and where MS shifting and final summing are performed in the logic operation unit, in embodiments.

FIG. 18 shows one example implementation of the computational memory of FIG. 10 with the noise reduction of FIG. 13 when IA values are bit-sliced, where MS shifting and 1-bit shifting are performed by the variable analog gain module, and where final summing is performed in the logic operation unit, in embodiments.

FIG. 19 shows one example implementation of the computational memory of FIG. 10 with the noise reduction of FIG. 13 when IA values are bit-sliced, where MS shifting, 1-bit shifting, and most and least summing are performed by the variable analog gain module, and where final summing is performed in the logic operation unit, in embodiments.

FIG. 20 shows one example implementation of the computational memory of FIG. 10 with the noise reduction of FIG. 11 when IA values are multi-bit, where the MS partial sum and the LS partial sum are performed within the RRAM, and where MS shifting and total summing are performed in the logic operation unit, in embodiments.

FIG. 21 shows one example implementation of the computational memory of FIG. 10 with the noise reduction of FIG. 11 when IA values are multi-bit, where the MS partial sum and the LS partial sum are performed within the RRAM, where MS shifting is performed in the variable analog gain module, and where total summing is performed in the logic operation unit, in embodiments.

FIG. 22 shows one example implementation of the computational memory of FIG. 10 with the noise reduction of FIG. 11 when IA values are multi-bit, where the MS partial sum and the LS partial sum are performed within the RRAM, and where MS shifting and total summing are performed in the variable analog gain module, in embodiments.

FIG. 23 is a schematic illustrating one example computer with weights stored in an RRAM, in embodiments.

FIG. 24A is a schematic diagram illustrating one example integration of the computational memory of FIG. 4 with an image sensor, in embodiments.

FIG. 24B is a schematic diagram illustrating example functionality between the image sensor and the ASIC die of FIG. 24A, in embodiments.

FIGS. 25A and 25B are schematic diagrams illustrating example stand alone modules that may be switch into circuit by variable analog gain module of FIG. 10 to apply a gain to LS output signals and/or MS output signals of FIGS. 11 and 13, in embodiments.

FIG. 26 is a schematic illustrating example configuration of two ADCs for capturing the LS output signal and a shifted MS output signal prior to summing, in embodiments.

FIGS. 27 and 28 are schematic diagrams illustrating cooperation between two ADCs to sum two analog values during conversion to a digital value, in embodiment.

### DETAILED DESCRIPTION OF THE EMBODIMENTS

Analog in-memory computing (AIMC) is an attractive solution to achieve low power/high efficiency operation with a small on-chip foot print for multiply accumulations, which is a main part of computations used by deep neural networks (DNNs). For example, AIMC implements analog multiply-accumulate cells (MACs) that provide a low-power and high efficiency alternative to digital computing. However, analog MACs have a lower signal-to-noise ratio (SNR) as compared to digital computing because of process, voltage, and temperature (PVT) variation across the analog MACs. Propagation of this noise to subsequent parts of the DNN may impact results and/or performance of the DNN. The present embodiments teach of methods for improving the SNR of AIMC such that the AIMC outputs may be successfully used in the subsequent parts of the DNN.

Although the following examples illustrate the user of AIMC with image sensors, the SNR improvement is not limited to use with image sensors, and may be applied to AIMC used in any kinds of embedded AI hardware that uses AIMC.

The following three use-cases are provided as examples. (1) Artificial intelligence (AI) application-specific integrated circuits (ASICs) support common DNN and frameworks by providing hardware accelerated by AIMC. This is relatively high performance area in the edge computing field, and security is a main application. Through use of the disclosed noise reduction for mixed in-memory computing, a high efficiency and higher accuracy computing is achieved. (2) On-sensor real-time computing is used for determining a region of interest (ROI) within an image, where the on-sensor real-time computing generates meta data for the sensed image. On-sensor real-time computing (e.g., on-the-fly computing) is used in augmented reality (AR), virtual reality (VR), and automotive applications for example. Advantageously, the disclosed noise reduction for mixed in-memory computing achieves low-power and higher accuracy computing operation. (3) Always-on low-power AI may be embedded in sensors that operate continuously (e.g., always on). Such embedded sensors are used for event detection in applications including security, doorbells, etc. Advantageously, the disclosed noise reduction for mixed in-memory computing allows AIMC to achieve low-power with higher accuracy computation than with prior, noisier, circuitry.

The traditional von Neumann architecture includes a digital data bus that couples memory with a processing unit, where the processing unit fetches a value from memory, process that value, and then stores the result back in the memory.

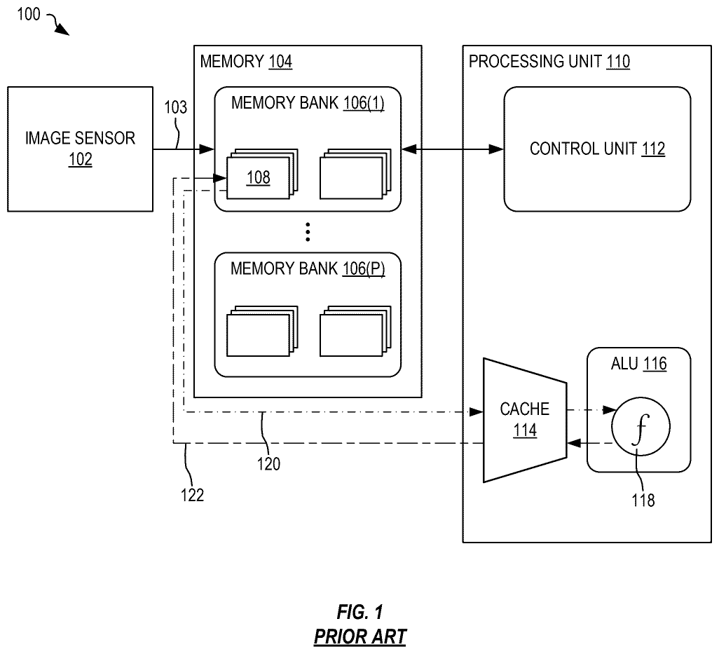

FIG. 1 is a schematic of a prior art computing system 100, implemented using von Neumann architecture, for processing image data 103 captured by an image sensor 102. Prior art computing system 100 includes a memory 104 with a plurality of memory banks 106(1)-106(P) and a processing unit 110 with a control unit 112, a cache 114, and an arithmetic logic unit (ALU) 116. Image data 103 is received from image sensor 102 and stored in cells 108 of memory bank 106(1). Control unit 112 causes a read 120 to transfer data of cell 108 to ALU 116, via cache 114, where ALU 116 implements a function 118 (e.g., a mathematical operation) on the data. Control unit 112 then causes a write 122 to transfer the resulting data back to cell 108 (or a different cell) of memory 104. In this architecture, function 118 is implemented external to memory 104, and as known in the art, read 120 and write 122 of data from and to memory 104 causes a significant bottleneck for memory intensive computation as required by a DNN.

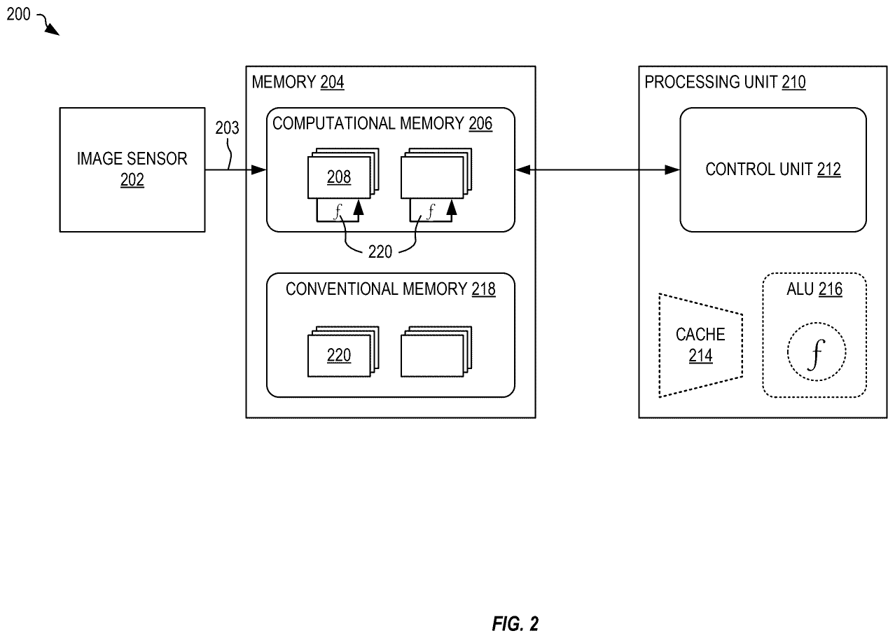

FIG. 2 is a schematic of one example analog in-memory computation (AIMC) system 200 for processing image data 203 from an image sensor 202, in embodiments. AIMC system 200 includes memory 204 with computational memory 206 and a processing unit 210 with a control unit 212, a cache 214, and an ALU 216. Computational memory 206 includes a plurality of cells 208 that are individually programmed to implement function 220 on data input to computational memory 206 as directed by control unit 212. Advantageously, function 220 is applied to data of cells 208 within computational memory 206 concurrently and without the need to move the data between memory 204 and processing unit 210. By way of example, transfer of data from Dynamic Randon Access Memory (DRAM) consumes over 600 picojoules (pJ) and transfer of data from SRAM consumes approximately 5-50 pJ. In contrast, in-memory computing (IMC) consumes sub-pJ. Accordingly, cache 214 and ALU 216 are not used to implement function 220 in this embodiment.

As shown in FIG. 2, memory 204 may also include conventional memory 218 in a von Neumann configuration where data is moved between conventional memory 218 and processing unit 210 using reads and writes. Accordingly, system 200 implements both AIMC within computational memory 206 and conventional data processing of data in conventional memory 218 using ALU 216.

With the increased demand for artificial intelligence processing, a data and thereby memory intensive type of processing for deep neural networks, the power required by data processing centers increases. Computational memory 206 reduces the power requirement by implementing function 220 in-memory and thereby avoiding repeated movement of data (e.g., read 120 and write 122 of FIG. 1) between memory 204 and a separate processing unit 210. Computational memory 206 provides fast, low-power computing with a small footprint that allows on-chip integration.

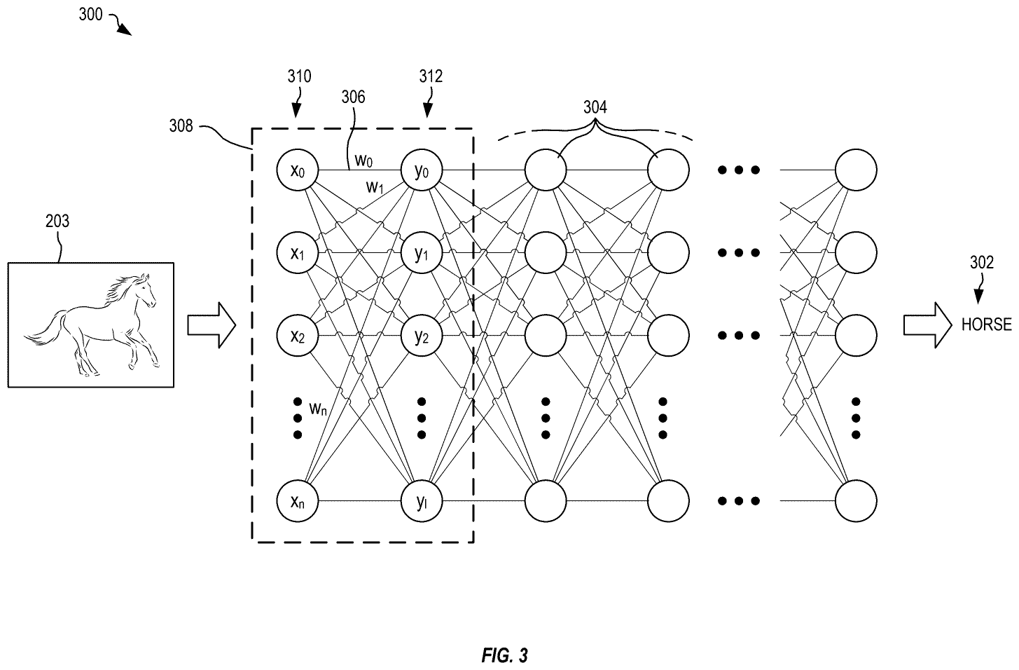

FIG. 3 is a schematic illustrating one example DNN 300 for processing image data 203 of FIG. 2 to generate an inference 302, which in this example indicates whether image data 203 includes an image of a horse. DNN 300 includes a plurality of multiply-accumulate cells (MACs) 304 (shown as circles), where each MAC 304 multiplies inputs from other cells by an associated weight 306 for each other cell, represented as lines between MACs 304, and accumulates the results. Per convention for a first layer 308 of DNN 300, an input array 310 of MACs 304 is referenced as x₀ through xₙ and an output array 312 (e.g., a next column of MACs 304 of DNN 300) is references as y₀ through yₜ, where y₀ through yₜ are the input array of a next layer of DNN 300. Weights 306 are referenced as w₀ through wₙ where w₀ represents weight 306 applied to a value received by y₀ from x₀, w₁ represents weight 306 applied to a value received by y₀ from x₁, and so on.

Following this convention, equation (1) illustrates function 220 to calculate y₀.

$${y}_{0} = \vec{x} \cdot \vec{W} = [ {x}_{1} … {x}_{j} … {x}_{n} ] \cdot [ \begin{matrix}{w}_{0} \\ ⋮ \\ {w}_{j} \\ ⋮ \\ {w}_{n}\end{matrix} ] = {\sum }_{j = 0}^{N - 1} {x}_{j} \cdot {w}_{j} \qquad ( 1 )$$

That is, equation (1) only calculates a value for y₀. The number of MACs 304 in each output array 312 for each layer 308 need not be the same as the number of MACs 304 in input array 310. That is, l is not required to equal n in FIG. 3.

### General

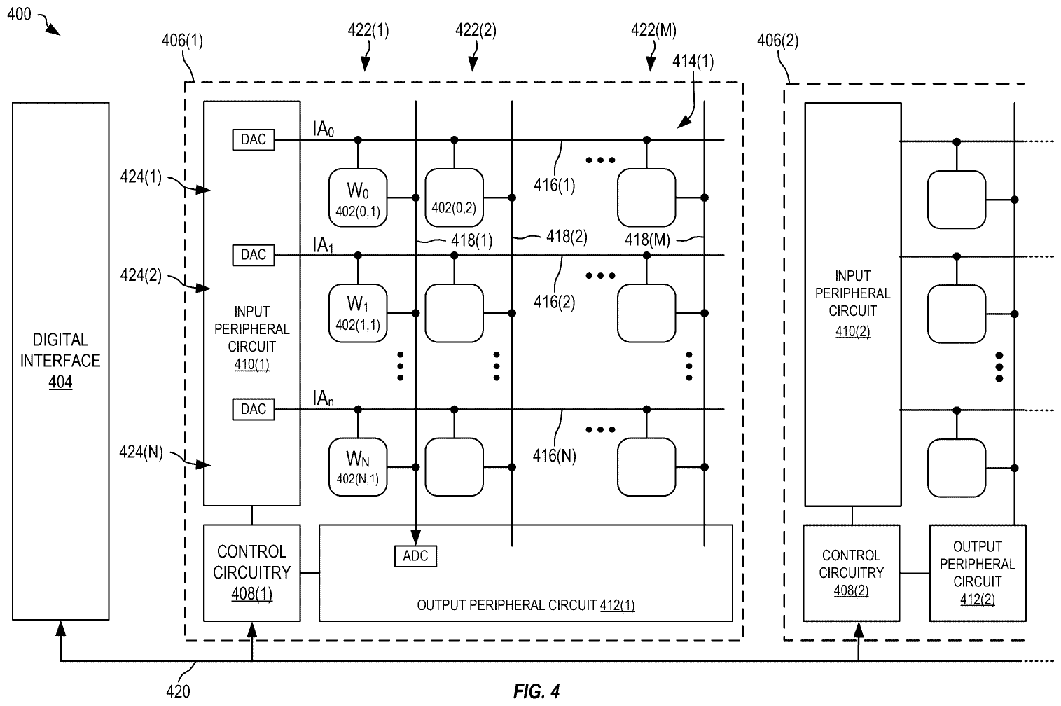

FIG. 4 is a schematic illustrating one example computational memory 400 that performs matrix vector multiplication (MVM), in embodiments. Computational memory 400 may represent computational memory 206 of FIG. 2.

Computational memory 400 includes a digital interface 404 and at least one computational block 406 (e.g., shown with computational block 406(1) and 406(2)), where each computational block 406 includes control circuitry 408 (e.g., control circuitry 408(1) and 408(2)), input peripheral circuits 410 (e.g., input peripheral circuits 410(1) and 410(2) that include input activation (IA) drivers and/or word line (WL) drivers), output peripheral circuits 412 (e.g., output peripheral circuits 412(1) and 412(2)), and a cross-bar array 414 (e.g., cross-bar array 414(1)) connecting a plurality of substantially identical analog cells 402. Digital interface 404 provides communication, via a digital bus 420, between computational memory 400 and host devices for example. Cross-bar array 414(1) is formed as a grid of non-connecting conductors, that includes a plurality of input conductors 416(1)-416(N) and a plurality of output conductors 418(1)-418(M) such that computational block 406 has M columns (e.g., columns 422(1)-422(M)) and N rows (e.g., rows 424(1)-424(N)).

Each cell 402 connects between one input conductor 416 and one output conductor 418, such that exactly one cell 402 connects between any pair of one input conductor 416 and one output conductor 418, as shown.

Control circuitry 408 implements a sequence controller that controls operation of each computational block 406, input peripheral circuits 410, output peripheral circuits 412, and cross-bar array 414 that performs MVM as used by DNN 300 of FIG. 3, for example. Control circuitry 408 controls input peripheral circuits 410 and/or output peripheral circuits 412 to program each cell 402 with a multiplier value, such as weight 306 of DNN 300. As shown in the example of FIG. 4, cell 402(0,1) is programed with weight W₀ and cell 402(1,1) is programed with weight W₁, and so on. The following examples use the digital weights of DNN 300 to represent the digital multipliers of cells 402.

Each cell 402 generates an analog output signal (e.g., current or charge) based on an IA input signal and the preloaded weight and since the output of cells 402 in one column 422 are coupled to one output conductor 418 the output signals (e.g., current or charge) on output conductor 418 are summed on that output conductor 418. The output signal is sensed within output peripheral circuits 412 by an analog-to-digital converter (ADC). The ADC may be implemented as a successive approximation register (SAR) ADC, or by other types of ADC without departing from the scope hereof. In certain embodiments, output peripheral circuits 412 includes one ADC per column. In other embodiments, output peripheral circuits 412 includes fewer ADCs that are multiplexed between multiple columns. Column 422 performs a MAC function represented by equation (2).

$$Q = {\sum }_{j = 0}^{N - 1} ( {V}_{j} \cdot t ) \cdot {G}_{j} \qquad ( 2 )$$

### Current-Domain Technology

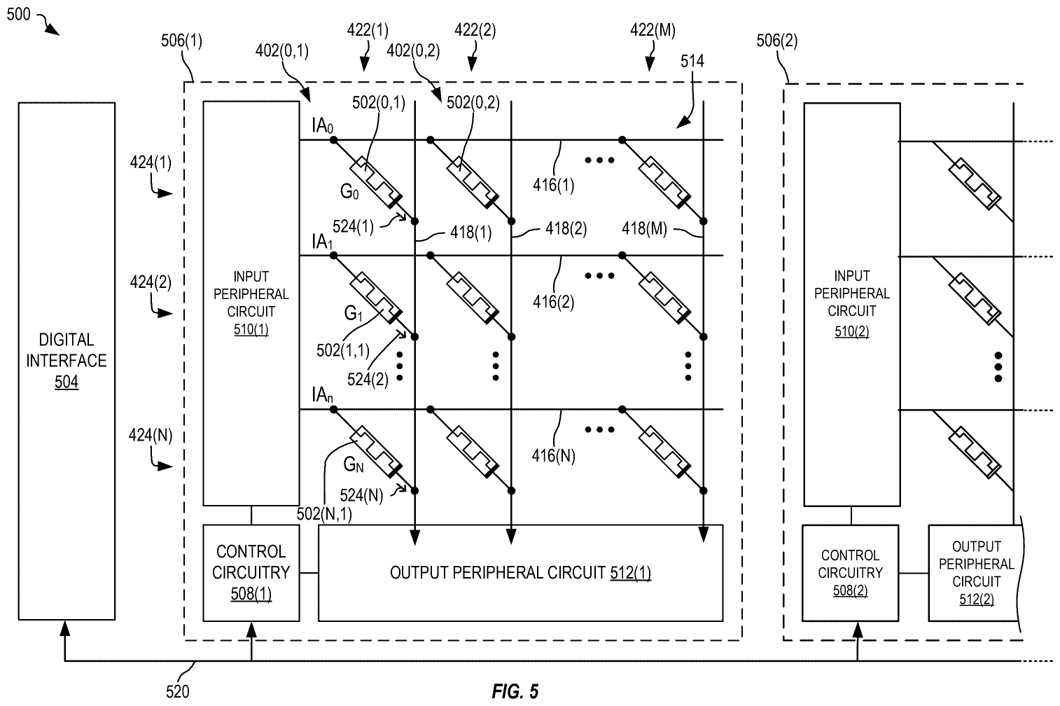

FIG. 5 is a schematic illustrating one example computational memory 500 implemented in a current-domain technology, in embodiments. Computational memory 500 is one example of computational memory 206 of FIG. 2. In this embodiment, each MACs 304 uses a memristor 502 that is preprogrammed with a gain representing a corresponding weight 306 of FIG. 3. However, computational memory 206 may be implemented using other technologies, such as a charge-domain technology that uses DRAM-IMC cells, SRAM, Flash, NVM (RRAM, PCM, STT-MRAM, SOT-MRAM, FeFET), for example.

Computational memory 500 includes a digital interface 504 and at least one computational block 506 (e.g., computational blocks 506(1) and 506(2)). Each computational block 506 includes control circuitry 508 (e.g., control circuitry 508(1) and 508(2)), input peripheral circuits 510 (e.g., input peripheral circuits 510(1) and 510(2)), output peripheral circuits 512 (e.g., output peripheral circuits 512(1) and 512(2)), and a cross-bar array 514 (e.g., cross-bar array 514(1)), formed as a grid of non-connecting conductors, that includes a plurality of input conductors 416(1)-416(N) and a plurality of output conductors 418(1)-418(M). Each one of the plurality of memristors 502 connects between one input conductor 416 and one output conductor 418, such that exactly one memristor 502 connects any pair of one input conductor 416 and one output conductor 418, as shown.

Computational memory 500 includes a communication bus 520 that connects digital interface 504 with control circuitry 508 of each computational block 506. Control circuitry 508 controls operation of input peripheral circuits 510 and output peripheral circuits 512 as describe in further detail below. Control circuitry 508 controls input peripheral circuits 510 and output peripheral circuits 512 to program each memristor 502 with a multiplier value, illustrated as a gain value corresponding to weight 306 of DNN 300. For example, memristor 502(0,1) is programed with gain G₀ that corresponds to weight w₀, and memristor 502(1,1) is programed with gain G₁ that corresponds to weight w₁, and so on.

In this example, computational block 506(1) implements functionality of first layer 308 of DNN 300 of FIG. 3, where a first column 422(1) of computational block 506(1) implements function 220 to determine a value of a first MAC 304 (e.g., y₀) of output array 312 based on inputs from input array 310 and weights w₀-wₙ. In one example of operation, control circuitry 508(1) controls input peripheral circuits 510(1) to drive input conductor 416(1) with a voltage representing x₀, input conductor 416(2) with a voltage representing x₁, and so on. For example, input peripheral circuits 510 include digital-to-analog converters (DACs) that convert 8-bit input values of input array 310 (e.g., x₀-xₙ) into voltages that drive input conductors 416. Concurrently, memristor 502(0,1) multiplies the voltage on input conductor 416(1) by G₀ to generate a current 524(1) on output conductor 418(1), memristor 502(1,1) multiplies the voltage on input conductor 416(2) by G₁ to generate a current 524(2) on output conductor 418(1), . . . and memristor 502(N,1) multiplies the voltage on input conductor 416(N) by G_{N} to generate a current 524(N) on output conductor 418(1). Other columns of computational block 506 operate similarly to generate output currents on corresponding output conductors 418. Control circuitry 508(1) then controls output peripheral circuits 512(1) to measure the current on output conductor 418(1) that represent a value for output array 312 (e.g., y₀-yₜ) of DNN 300. The current measured by output peripheral circuits 512(1) on output conductor 418(1) is the sum of currents 524(1)-(N), such that column 422(1) performs a MAC function. This is represented by equation (3).

$$I = {\sum }_{j = 0}^{N - 1} {V}_{j} \cdot {G}_{j} \qquad ( 3 )$$

### Charge-Domain Technology

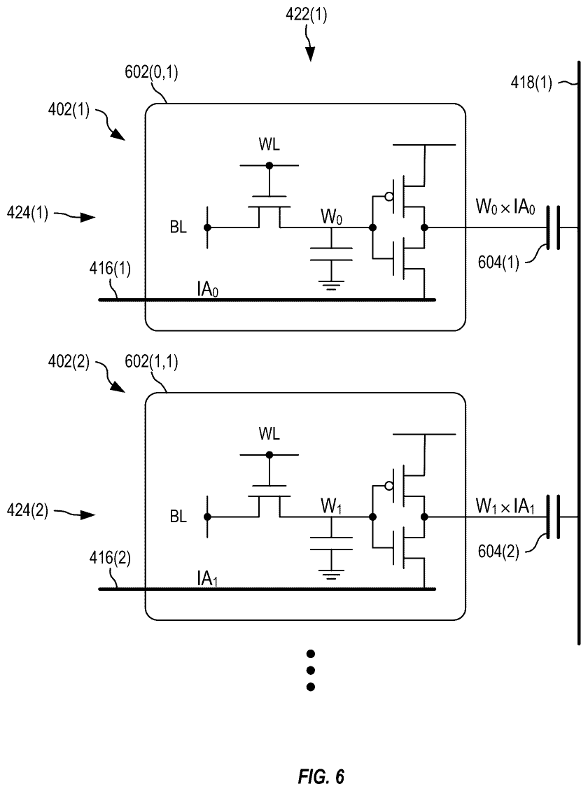

FIG. 6 is a schematic illustrating example DRAM circuits 602 that implement cells 402 of FIG. 4 in a charge-domain, in embodiments. In this embodiment, each cell 402 includes a DRAM circuit 602 and a coupling capacitor 604 (e.g., coupling capacitors 604(1) and 604(2)).

Control circuitry 408 controls input peripheral circuits 410 and/or output peripheral circuits 412 to program each DRAM circuit 602 with a gain value corresponding to one weight 306 of DNN 300. For example, DRAM circuit 602(0,1) is programed with gain G₀ that corresponds to weight w₀, and DRAM circuit 602(1,1) is programed with gain G₁ that corresponds to weight w₁, and so on.

In one example of operation, DRAM circuit 602 generates an output charge that represents IA (e.g., an input current representative of an input value) multiplied by the stored weight 306. The output charge is coupled to one output conductor 418 via coupling capacitor 604 such that the charge on one output conductor 418 is a sum of charges generated by cells 402 coupled to that output conductor 418. Accordingly, the column 422(1) performs a MAC function. This is represented by equation (4).

$$Q = {\sum }_{j = 0}^{N - 1} ( {V}_{j} \cdot t ) \cdot {G}_{j} \qquad ( 4 )$$

As noted above, PVT introduces unwanted variation in analog circuits (e.g., cells 402, input peripheral circuits 410, and output peripheral circuits 412 of computational memory 400) which may be measured as a signal-to-quantization-noise ratio (SQNR). SQNR is conventionally reduced by truncating the least-significant bits of resulting values. However, where each column 422 of computational block 406 represents one MAC 304 of output array 312 of first layer 308, the number of bits each cell 402 effectively stores is already limited, and truncating the least significant bits further reduces the bit width of each cell 402. The reduced accuracy may be insignificant for certain applications of DNN 300 but may be significant for others. Accordingly, it is desirable to improve the SQNR without reducing the effective bit width of the calculations.

### ADC Range Selection

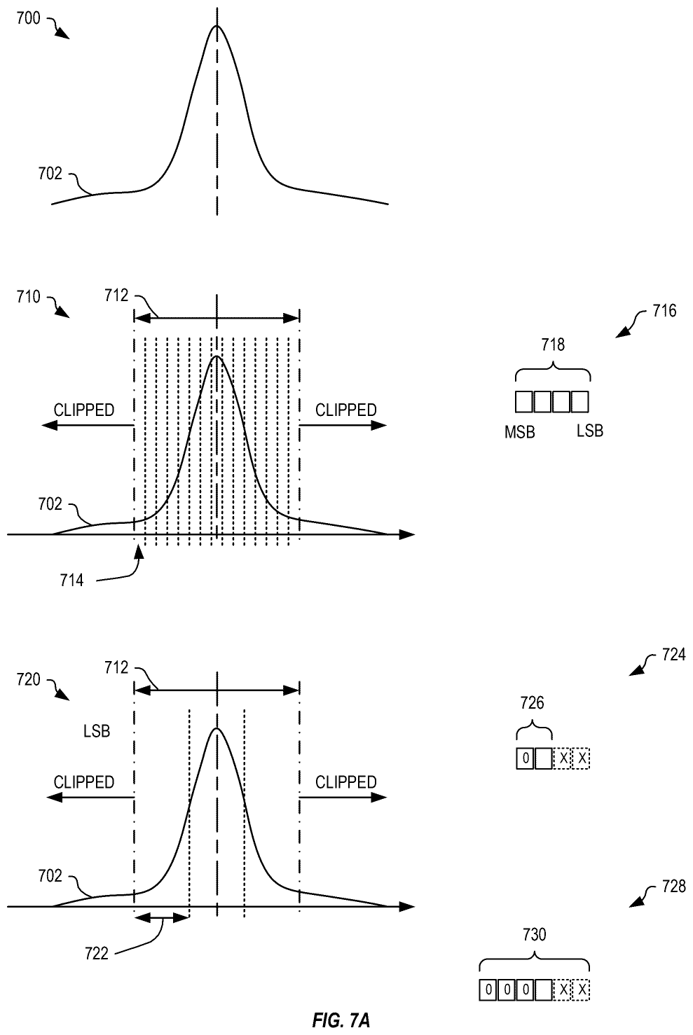

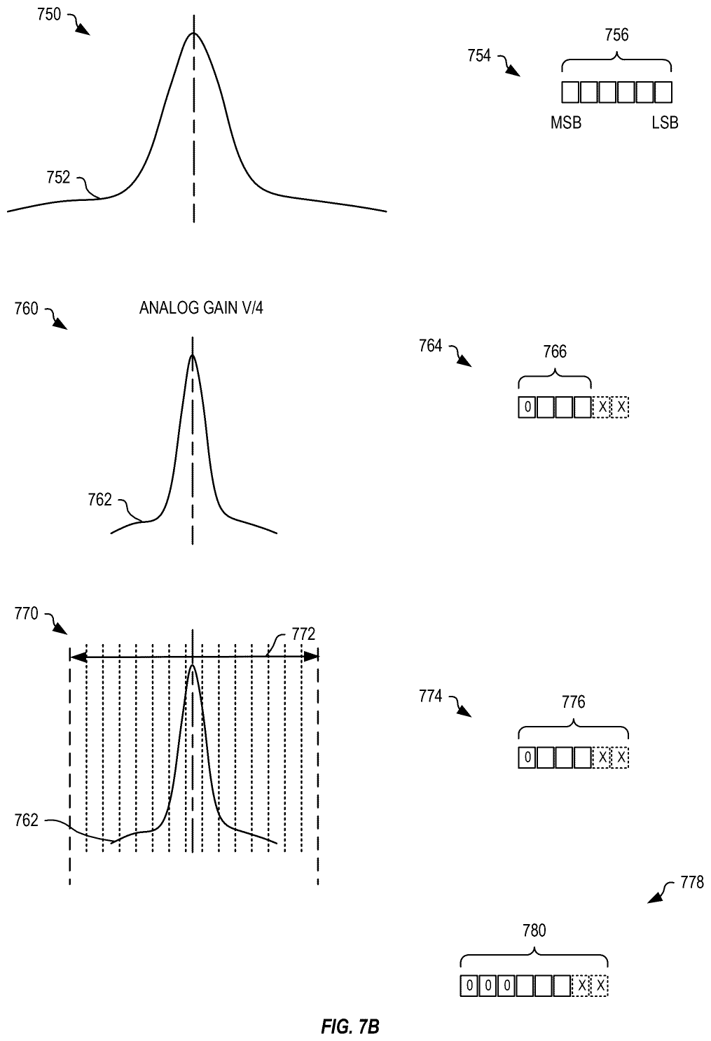

FIGS. 7A and 7B illustrate example operation of analog-to-digital converters (ADC_ for capturing values from output conductors 418 of FIG. 4, in embodiments.

For clarity of illustration, a four-bit ADC is illustrated; however, the ADC may have more or fewer bits without departing from the scope hereof.

As noted above, PVT and quantization errors introduce undesirable noise that propagates through DNN 300. Bit precision and range of captured values is controlled by selecting an appropriate ADC conversion range 712 that is tuned according to a distribution curve 702 of output of columns 422 of computational block 406 of FIG. 4 and a desired precision (e.g., four-bits). In the digital domain, the number of bits captured by the ADC may be controlled such that LS bits are not captured and thus reducing noise. In the analog domain, a gain (e.g., V/4) may be applied to the analog signal prior to capture of a value by the ADC. Accordingly, the analog signal is reduced such that the noise is outside the capture range of the ADC.

In the example of FIG. 7A, graph 700 illustrates an example distribution curve 702 of the analog values of output conductors 418. Graph 710 illustrates a capture range 712 of the ADC that is positioned to capture the most important values of distribution curve 702. In this example, the analog signal and capture range 712 are not changed. As shown in graph 710, capture range 712 is divided into fifteen sub-ranges and the ADC captures a value 716 of four bits 718. Accordingly, a LSB of value 716 is defined with a corresponding LSB sub-range 714. Values outside capture range 712 are not captured by the ADC and are clipped.

Graph 720 illustrates distribution curve 702 and the same capture range 712, but where the ADC is controlled to capture a value 724 with only two-bits 726. Accordingly, capture range 712 is divided into three sub-ranges such that the ADC operates with an LSB defined with an LSB sub-range 722, which is four times the width of LSB sub-range 714. In another example, where a bit depth of an ADC is changed from six-bits to four-bits, without changing the capture range V_dr of the ADC, the LSB sub-range changes from V_dr/2⁶ to V_dr/2⁴. Additional bit shifting may be affected in either the digital or analog domain to generate a value 728 with the required number of bits 730.

In the example of FIG. 7B, graph 750 illustrates an example distribution curve 752 of the analog values of output conductors 418. In this example, the output distribution range corresponds to a value 754 that is captured in six bits 756. Graph 760 illustrates a narrowed distribution curve 762 after a gain of V/4 has been applied (e.g., to the analog output of output conductors 418), resulting in a reduced distribution range, where narrowed distribution curve 762 may be captured as a value 764 that requires four bits 766 as compared to six bits 756 of value 754. Graph 770 shows narrowed distribution curve 762 is within a capture range 772 of a four-bit ADC, such that narrowed distribution curve 762 is captured as ADC captured information 774 with four-bits 776.

This solution is particularly useful when the analog signal on output conductor 418 is greater than capture range 772 of the ADC. By applying a gain to reduce distribution curve 752 to narrowed distribution curve 762, important parts of the analog signal are shifted to be within capture range 772 and are therefore captured by the ADCs.

### Weight Slicing

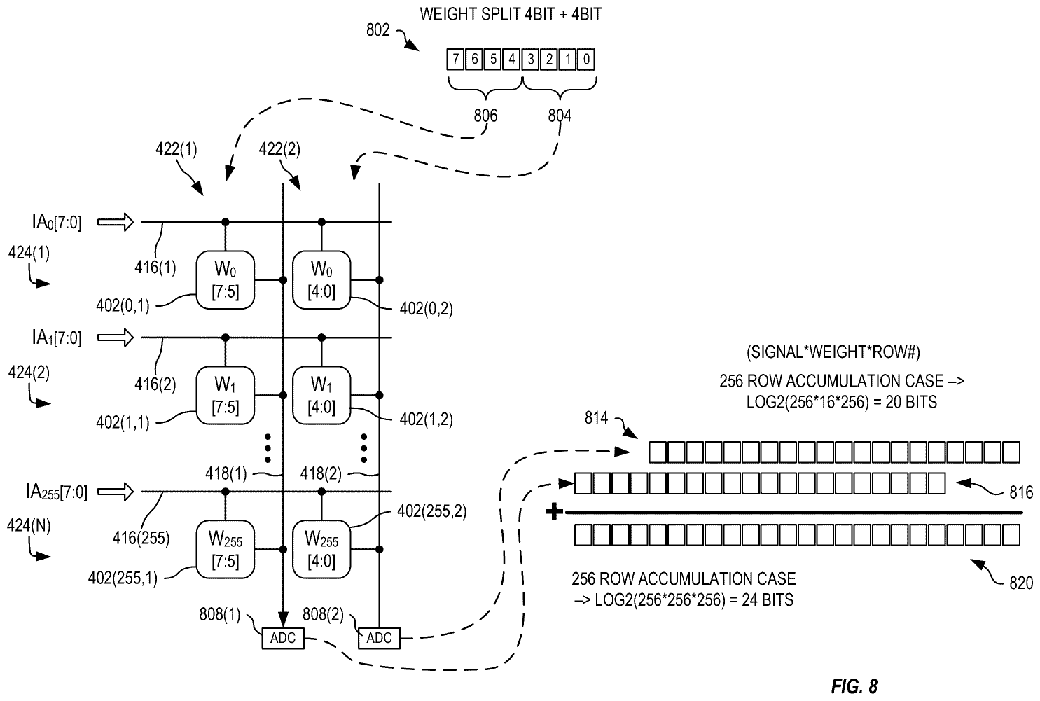

FIG. 8 is a schematic illustrating splitting of a digital weight 802 between two cells of computational memory 400 to increase a bit-width of computational memory 400 for an eight-bit input activation, in embodiments. Splitting of digital weight 802 over two (or more) columns 422 of computational memory 400 reduces the number of levels required in each cell to store the digital weight. Further, by using two columns 422 for each weight, the number of levels available to store the weight is increased, and thus the resolution of computational memory 400 is increased. For example, where the implementation of cell 402 has a storage resolution of four bits (e.g., stores only sixteen distinct levels), using two cells for each multiplication allows for an eight-bit resolution.

Digital weight 802 (e.g., weight W₀) has T bits that are divided into a low nibble 804 having L LS bits and a high nibble 806 having H MS bits (e.g., T-L—the remaining bits of digital weight 802). In the example of FIG. 8, digital weight 802 has eight bits (e.g., T=8), and each of low nibble 804 and high nibble 806 has four bits (e.g., L=4 and H=4); however, digital weight 802 may have more or fewer bits without departing from the scope hereof. For example, where digital weight 802 has six bits, each of low nibble 804 and high nibble 806 has three bits. In another example, where digital weight 802 has ten bits, each of low nibble 804 and high nibble 806 has five bits. Further, digital weight 802 may be split into multiple portions (e.g., a greatest-significant (GS) portion, an MS portion, and a LS portion, but may include more portions without departing from the scope hereof), where each portion, represented as an analog signal, is preloaded into a different column 422 of cross-bar array 414. For example, the GS portion represented as an analog signal is preloaded into a third cell of a third column of the cross-bar array of analog cells, and a GS partial sum is captured from a third output conductor of the third column. The GS partial sum is multiplied by 2 raised to the power (L+H), and the MS portion is multiplied by 2 raised to the power L. The LS partial sums, the MS partial sums, and the GS partial sums are added to form the resulting value for one node of DNN 300, for example. In this example, the portions do not overlap.

High nibble 806, represented as an analog signal, is preloaded into cells 402 of column 422(1) and low nibble 804, represented as an analog signal, is preloaded into cells 402 of column 422(2). As appreciated, the order of low and high nibbles and/or columns 422(1) and 422(2) may be swapped without departing from the scope hereof. To calculate the resulting MAC value, a first circuit 808(1) measures a least significant (LS) partial sum 814 of a current on output conductor 418(1) and a second circuit 808(2) measures a most significant (MS) partial sum 816 of a current on output conductor 418(2). LS partial sum 814 and MS partial sum 816, which is first multiplied by 2 raised to the power L (e.g., shifted by L bits), since high nibble 806 was effectively divided by 24 by the split, are then summed (e.g., as digital values in the digital domain) to form a resulting value 820 for y₀. In the example of FIG. 8, since each IA value is eight-bits, each low nibble 804 and high nibble 806 is four-bits, and the number of rows 424(N) is 256, each of LS partial sum 814 and MS partial sum 816 is twenty-bits in length and resulting value 820 is twenty-four-bits in length. This functionality is summarized in equations (5), (6), and (7).

$${y}_{0} = \vec{IA} \cdot {\vec{W}}^{{}_{{}_{T}}} = [ {IA}_{8 {b}_{-} 0} … {IA}_{8 {b}_{-} 255} ] \cdot [ \begin{matrix}{W}_{8 {b}_{-} 0} \\ ⋮ \\ {W}_{8 {b}_{-} 255}\end{matrix} ] \qquad ( 5 )$$

$$= {\sum }_{i = 0}^{{2}^{8} - 1} {IA}_{8 {b}_{-} i} \cdot {W}_{8 {b}_{-} i} \qquad ( 6 )$$

$$= {\sum }_{i = 0}^{{2}^{8} - 1} {IA}_{8 {b}_{-} i} \cdot {W}_{{a}_{-} 8 {b [ 3 : 0 ]}_{-} i} + {2}^{4} \cdot {\sum }_{i = 0}^{{2}^{8} - 1} {IA}_{8 {b}_{-} i} \cdot {W}_{{b}_{-} 8 {b [ 7 : 4 ]}_{-} i} \qquad ( 7 )$$

Although this solution improves resolution, it may also decrease SQNR, since noise from operation of column 422(1), which manifests in the least significant few bits of MS partial sum 816, is multiplied by 24 (e.g., shifted by L bits) prior to being added with LS partial sum 814 to form resulting value 820. Thus, the noise from operation of column 422(1) may propagate to subsequent layers of DNN 300. As noted above, digital weight may be divided into multiple portions, and multiple partial sums are generated and added to form the resulting value.

### Weight Slicing with Input Bit Slicing

The following example illustrates inputting of digital IA values one bit at a time. However, digital IA values may be sliced into fewer portions, where each portion has multiple bits. For example, IA values may be split into nibbles and processed in two cycles of computation al memory 400.

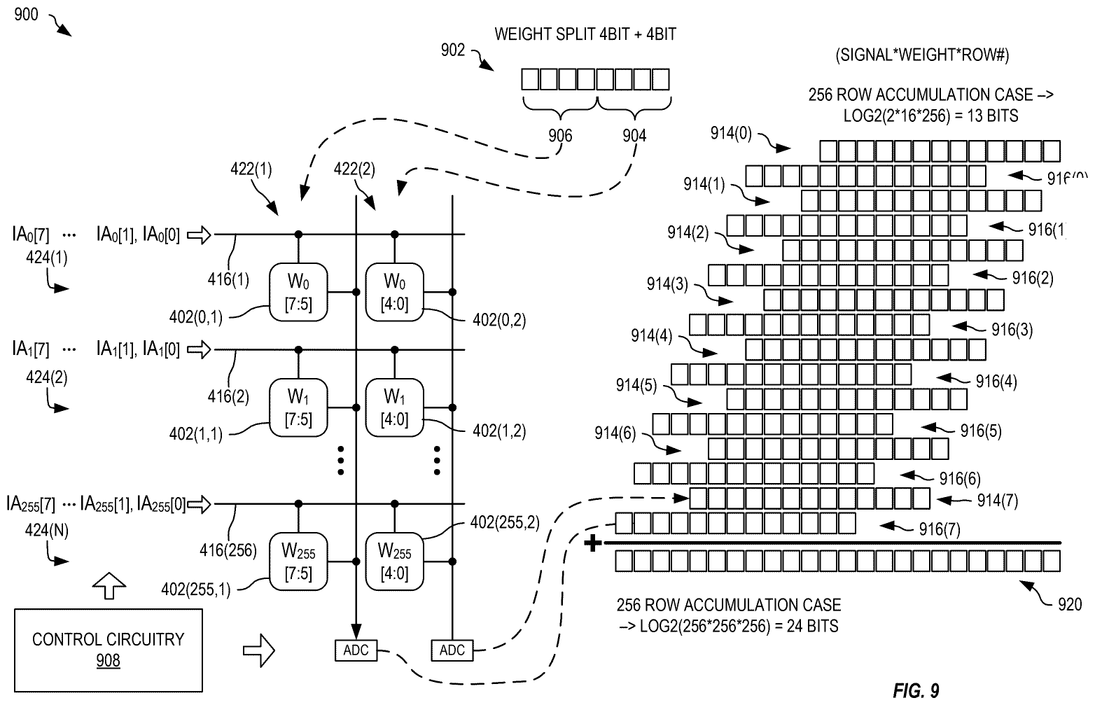

FIG. 9 is a schematic illustrating splitting of a digital weight 902 between two cells of computational memory 400 to increase a bit-width of computational memory 400 for bit-sliced input activation, in embodiments. In the example of FIG. 9, each digital IA value has eight bits (e.g., P=8). For input bit-slicing, each bit of a digital IA (e.g., each bit of one of IA₀-IA₂₅₅) is input to one input conductor 416 (e.g., as a constant voltage for each bit value of zero and one) such that P cycles of computational memory 400 are required to process each digital IA value. Digital weight 902 (e.g., weight W₀) has eight-bits that are divided into a LS nibble 904 and a MS nibble 906, where MS nibble 906, represented as an analog signal, is preloaded into cell 402(0,1) of column 422(1) and LS nibble 904, represented as an analog signal, is preloaded into cell 402(0,2) (e.g., a first cell) of column 422(2). Unlike FIG. 8 where IA is input as an eight-bit value, in the example of FIG. 9, bit zero (e.g., the LSB) of each IA is processed in a first cycle (e.g., j=0) to determine LS partial sum 914(0) and MS partial sum 916(0). In a second cycle (e.g., j=1), bit one of each IA is processed to determine LS partial sum 914(1) and MS partial sum 916(1), and so on until all eight bits are processed to generate LS and MS pairs of partial sums. Accordingly, each bit of the multi-bit IA is processed in a different cycle of computational memory 400.

Each pair of LS partial sum 914 and MS partial sum 916 is shifted left by a number of bits corresponding to a position of the IA bit being input. For example, there is no shift of LS partial sum 914 and MS partial sum 916 when the LS bit (e.g., bit position zero) of IA is input; LS partial sum 914 and MS partial sum 916 are shifted left by one bit when a next bit (e.g., bit position 1) of IA is input, and so on until LS partial sum 914 and MS partial sum 916 are both shifted left by seven bits when the MS bit (e.g., bit 7) of IA is input. In certain embodiments, the shift is implemented based on a processing cycle number (e.g., j from 0 to P−1 where P is the number of bits in each digital IA value) where the cycle number starts at zero for each LS bit of the IA being input. Further, each MS partial sum 916 is shifted left by L bits relative to its corresponding LS partial sum 914 since MS nibble 906 was effectively divided by 24 by the split. For example, where L is four, MS partial sum 916(0) is shifted left by four bits relative to LS partial sum 914(0). LS partial sums 914(0)-(7) and MS partial sums 916(0)-(7) are then summed to form resulting value 920. This shifting and summing typically occurs in the digital domain.

In the example of FIG. 9, since IA values are bit-sliced and input one bit at a time and each LS nibble 904 and MS nibble 906 is four-bits (e.g., L=4 and H=4), where the number of rows 424(N) in each column is 256, each LS partial sum 914 and MS partial sum 916 requires thirteen-bits. Resulting value 920 requires twenty-four-bits (e.g., similar to resulting value 820 of FIG. 8) to accommodate the summation of the shifted LS partial sums 914 and MS partial sums 916 for each cycle. This functionality is summarized in equations (8), (9), and (10).

$${y}_{0} = \vec{IA} \cdot {\vec{W}}^{{}_{{}_{T}}} = {\sum }_{i = 0}^{{2}^{8} - 1} {IA}_{8 {b}_{-} i} \cdot {W}_{8 {b}_{-} i} \qquad ( 8 )$$

$$= [ {2}^{0} … {2}^{7} ] \cdot [ \begin{matrix}{IA}_{8 {b}_{-} 0} [ 0 ] & … & {IA}_{8 {b}_{-} 255} [ 0 ] \\ ⋮ & ⋱ & ⋮ \\ {IA}_{8 {b}_{-} 0} [ 7 ] & … & {IA}_{8 {b}_{-} 255} [ 7 ]\end{matrix} ] \cdot ( [ \begin{matrix}{W}_{a \_ 8 b [ 3 : 0 ] \_ 0} \\ ⋮ \\ {W}_{a \_ 8 b [ 3 : 0 ] \_ 255}\end{matrix} ] + {2}^{4} \cdot [ \begin{matrix}{W}_{b \_ 8 b [ 7 : 5 ] \_ 0} \\ ⋮ \\ {W}_{b \_ 8 b [ 7 : 5 \_ 255}\end{matrix} ] ) \qquad ( 9 )$$

$$= {\sum }_{j = 0}^{8 - 1} {2}^{j} \cdot ( {\sum }_{i = 0}^{{2}^{8} - 1} {IA}_{8 {b}_{-} i} [ j ] \cdot {W}_{a \_ 8 b [ 3 : 0 ] \_ i} + {2}^{4} \cdot {\sum }_{i = 0}^{{2}^{8} - 1} {IA}_{8 {b}_{-} i} [ j ] \cdot {W}_{b \_ 8 b [ 7 : 4 ] \_ i} ) \qquad ( 10 )$$

Effectively, this solution performs calculations on fewer bits within each cell 402, thereby this solution improves resolution, reduces the number of bits required for the ADC, and also decreases SQNR, since noise from operation of columns 422(1) and 422(2), which manifests in the least significant few bits of LS partial sums 914 and MS partial sums 916, is not used, and therefore the noise is not shifted and added into resulting value 920. Accordingly, less noise is introduced at higher bit positions. and less noise propagates through subsequent computations of DNN 300. As described above, digital weight may have more or fewer bits and may be divide into multiple portions that are applied to different columns of the cross-bar array, without departing from the scope hereof.

### Improved Noise Reduction

The embodiments disclosed herein improve the state of the art for mixed analog/digital (e.g., hybrid) in-memory computation. Conventionally, the state of the art uses single-bit multiplication and analog summation (charge mode or current mode) over neighboring activation levels. Bit shift and summation for an eight bit word length is typically performed in the digital domain for each input bit of the IA. In this model, one column of cells calculates a value for a next layer (e.g., MACs 304) of a DNN (e.g., DNN 300).

The embodiments disclosed herein implement a multi-bit (e.g., 4 b+4 b, 5 b+5 b, 3 b+5 b) multiplication+multi-bit shift in analog-digital mixed mode (e.g., current mode in case of memristor use, or alternatively charge mode for other memory types). A key aspect of the noise reduction for mixed in-memory computing embodiments described herein is the realization that by dividing the weight over multiple cells, multiplying and accumulating each column, and recombining the totals allows the noise (e.g., LSB(s) of result for each multiplication and summation) to be ignored and thereby noise propagation through subsequent layers of DNN 300 is reduced.

### Improved Hardware

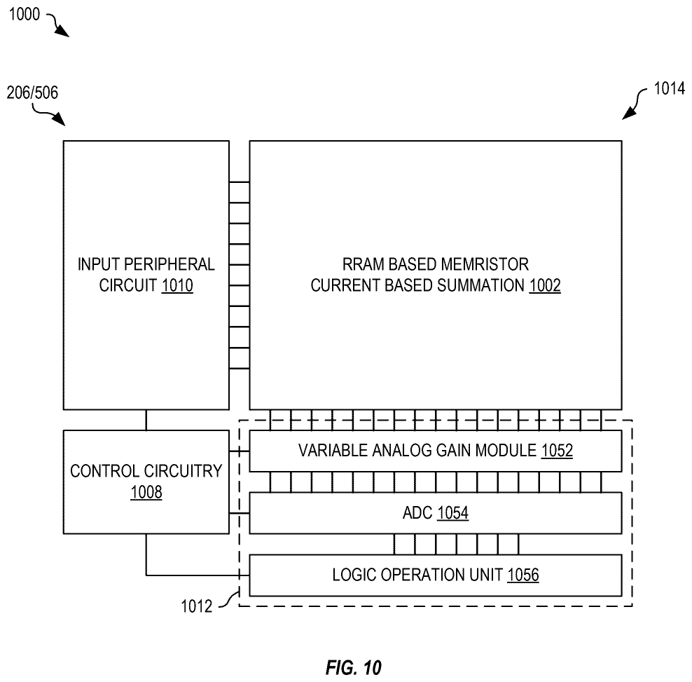

FIG. 10 is a schematic illustrating one example current-domain computational memory 1000 with improved noise reduction and increased SQNR, in embodiments. Computational memory 1000 represents computational memory 206 of FIG. 2 and/or computational block 506 of FIG. 5, for example. However, computational memory 1000 includes additional features that improve SQNR and functionality of computational memory 1000. In this example, computational memory 1000 operates with analog representations of eight-bit IAs and eight-bit digital weights in a current-domain; however, computational memory 1000 may also operate to represent other bit lengths and/or in a charge-domain without departing from the scope hereof.

Computational memory 1000 includes a crossbar 1014 implemented as a resistive random access memory (RRAM) 1002 that uses a memristor array, similar to memristors 502 of FIG. 5, that performs current-based summation. Computational memory 1000 also includes a control circuitry 1008 that is similar to control circuitry 408 and/or 508, and an input peripheral circuit 1010 that is similar to input peripheral circuit 410(1) and/or input peripheral circuit 510(1). Input peripheral circuit 1010 may also include circuitry for preloading RRAM 1002. For example, input peripheral circuit 1010 is controlled by control circuitry 1008 to preload RRAM 1002 with analog representations of digital weights of DNN 300 as described herein. Further, computational memory 1000 allows slicing of digital weights across two or more columns of RRAM 1002.

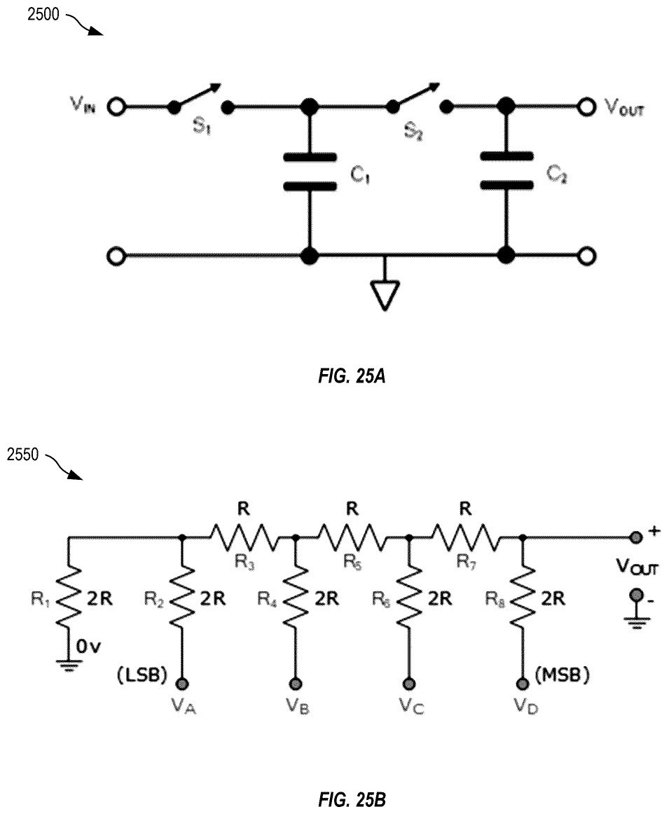

Computational memory 1000 includes an output peripheral circuit 1012 that is improved over output peripheral circuit 412 and output peripheral circuit 512. For example, output peripheral circuit 1012 may include a variable analog gain module 1052 that electrically couples to RRAM 1002, ADC 1054 (e.g., a SAR ADC) with a current digital-to-analog converter (IDAC) or a capacitive digital-to-analog converter (CDAC) that are controllable by control circuitry 1008 to change a gain of signals from RRAM 1002 and/or variable analog gain module 1052. For example, variable analog gain module 1052 may include one or more of an R-2R ladder module (e.g., see FIG. 25B) and a switched capacitor module (e.g., see FIG. 25A) to implement gains. Computational memory 1000 also includes a logic operation unit 1056 that may add partial sums generated by ADC 1054 to determine values for subsequent layers of DNN 300 for example.

Computational memory 1000 may be implemented as one of two main embodiments, Embodiment A and Embodiment B, described in detail below. These embodiments illustrate two different method of computational memory 1000 to process IA. In embodiment A, computational memory 1000 processes IA as a multibit value whereas in embodiment B, computational memory 1000 processes IA one bit at a time, which may be referred to as bit-slicing. Where IA is bit sliced, multiple cycles of multiply and summation are required to determine each resulting value (e.g., a value for use is a subsequent layer of the DNN).

### Embodiment A—Multi-Bit Input

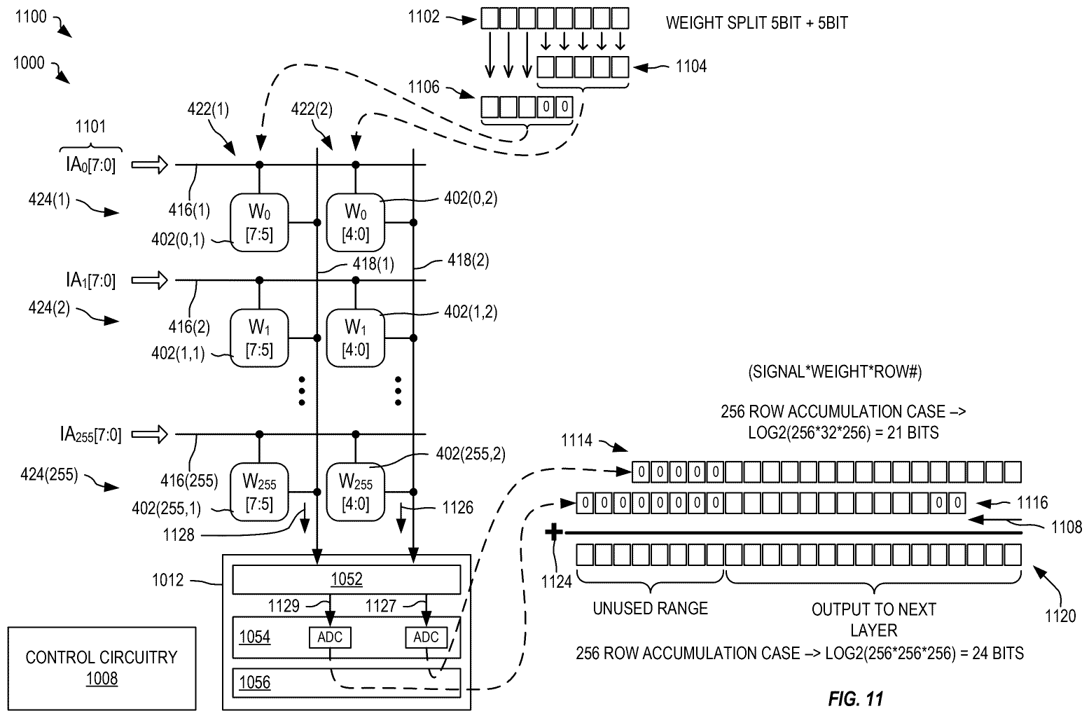

FIG. 11 is a schematic diagram illustrating example operation of computational memory 1000 of FIG. 10 with noise reduction 1100 for multi-bit AI values 1101, in embodiments. FIGS. 10 and 11 are best viewed together with the following description. In this example, each digital weight (e.g., a digital weight 1102 representing weight W₀ of DNN 300) is eight bits (e.g., T=8), that is divided into an LS portion 1104 that has five-bits (e.g., where L is five) that are set to the five LS bits of digital weight 1102 and an MS portion 1106 that is five-bits that has its three most significant bits set to the value of the three most-significant bits (e.g., H is three) of digital weight 1102 and its two least significant bits set to zero. That is, the LS portion holds the L least significant bits of the digital weight, while the MS portion holds the H (e.g., T−L) most significant bits of the digital weight multiplied by 2^{(L-(L-H))}. In this example, MS portion 1106 has the same number of bits as LS portion 1104. For example, where T is eight, L is five, and H is three, the five LS bits of the digital weight form the LS weight portion and the three MS bits of the digital weight are stored in the three MS bits of the MS weight portion and the two LS bits of the MS weight portion are set to zero, such that the MS weight portion also has five-bits. The dividing of the digital weight and forming of MS portion 1106 may be performed external to control circuitry 1008.

LS portion 1104 is applied to column 422(2) and MS portion 1106 is applied to column 422(1). In certain embodiments, digital weight 1102 is split into more than two portions, where each portion is represented as an analog signal that is preloaded into a different column 422 of computational memory 1000. This effectively splits the weight multiplication over multiple columns, reducing the bit requirement of each column and thereby reducing noise, where the captured partial results from these columns are scaled and summed to form the resulting value. In the example of FIG. 11, MS partial sum 1116 is appropriately scaled prior to summing with LS partial sum 1114.

Control circuitry 1008 controls input peripheral circuit 1010 to apply input activators IA₀-IA₂₅₅ (e.g., each an eight-bit value converted into an analog signal by a DAC) to input conductors 416(0)-416(255), respectively, causing each cell 402 to apply a current, corresponding to the multiplication of the weight and IA, to one output conductor 418 of that column 422. For example, output conductor 418(1) of column 422(1) carries an MS output signal 1128 indicative of MAC processing of activators IA₀-IA₂₅₅ multiplied by MS portion 1106 and summed in column 422(1) and output conductor 418(2) of column 422(2) carries an LS output signal 1126 indicative of MAC processing of activators IA₀-IA₂₅₅ multiplied by LS portion 1104 and summed in column 422(2). Control circuitry 1008 sets a gain (e.g., using one or both of variable analog gain module 1052 and ADCs 1054) for each of column 422(1) and column 422(2).

In this example, the number of rows in each column is 256. A maximum value output from each column is 256 (IA input of 8-bits)×32 (Weight of 5-bits)×256 (number of rows being summed in each column)=2,097,152. The number of bits required to store this value is Log₂(2,097,152)=21-bits. That is, each of LS partial sum 1114 and MS partial sum 1116 requires 21-bits to store the full value range. A total number of bits required for resulting value 1120 is Log₂(256 (IA input of 8-bits)×256 (Weight of 8-bits)×256 (number of rows being summed in each column))=24-bits. Resulting value 1120 is determined by performing an MS shift 1108 (e.g., indicated by arrow) that shifts MS partial sum 1116 left by three bits relative to LS partial sum 1114 and then by summing LS partial sum 1114 and MS partial sum 1116. MS shift 1108 implements a multiplication using a scaling-factor of 2^{(L-(L-H)} that corrects for MS portion 1106 being effectively divided by 2^{(L-(L-H))} when digital weight 1102 was split into LS portion 1104 and MS portion 1106). The MS 8-bits of resulting value 1120 are unused range, and the training sixteen-bits of resulting value 1120 are output to subsequent layers of DNN 300.

In one example of operation, control circuitry 1008 implements MS shift 1108 by controlling variable analog gain module 1052 to implement a gain of 2^{(L-(L-H)} to MS output signal 1128 to form MS adjusted signal 1129, and then capturing MS adjusted signal 1129 as MS partial sum 1116 using ADCs 1054. In this example, the five LS-bits of MS partial sum 1116 are set to zero. Control circuitry 1008 also controls ADCs 1054 to capture LS output signal 1126 as LS partial sum 1114. Control circuitry 1008 then controls logic operation unit 1056 to sum LS partial sum 1114 and MS partial sum 1116 to form resulting value 1120.

In certain embodiments, after implementing MS shift 1108, control circuitry 1008 controls variable analog gain module 1052 to sum LS output signal 1126 and MS output signal 1128 prior to using ADCs 1054 to capture the summed signal as resulting value 1120.

Advantageously, since MS portion 1106 has its (L−H) (e.g., two) least significant bits set to zero, and because the corresponding least significant bits of MS partial sum 1116 result as zero, without the loss of information, SQNR of computational memory 1000 is significantly improved, since noise that would occur in the LS bits of the conversion to digital of the output from cross-bar array 414 are zeroed. The MS three bits of digital weight 1102 are effectively multiplied by 2^{(L-H)} (e.g., four in the example of FIG. 11) to form MS portion 1106, thereby moving results of calculations performed by column 422 (1) above LSB noise. Since, in operation of DNN 300, noise propagates from one layer to the next and is amplified (e.g., due to bit shift operations), the reduction of noise within each cell 402 significantly improves performance of DNN 300. Without the noise reduction method, noise in the LS bits of MS partial sum 1116 would propagate at more significant bits (e.g., bit positions four and five in this example) of resulting value 1120. The disclosed embodiments reduce propagation of noise to subsequent layers of DNN 300 and the reliability of DNN 300 is thereby improved.

Equations (11), (12), and (13) represent functionality of computational memory 1000 for this embodiment.

$${y}_{0} = \vec{IA} \cdot {\vec{W}}^{{}_{{}_{T}}} \qquad ( 11 )$$

$${\sum }_{i = 0}^{{2}^{8} - 1} {IA}_{8 {b}_{-} i} \cdot {W}_{8 b\_i} \qquad ( 12 )$$

$$= {\sum }_{i = 0}^{{2}^{8} - 1} {IA}_{8 {b}_{-} i} \cdot {W}_{a \_ 8 b [ 4 : 0 ] \_ i} + {2}^{( 5 - 2 )} \cdot {\sum }_{i = 0}^{{2}^{8} - 1} {IA}_{8 {b}_{-} i} \cdot {W}_{b \_ 8 b [ 7 : 5 ] \_ i} \qquad ( 13 )$$

This embodiment may be applicable for the below condition of equation (14):

$${y}_{0} = {\sum }_{i = 0}^{{2}^{x} - 1} {IA}_{xb \_ i} \cdot {W}_{a \_ x b [ ( k - 1 ) : 0 ] \_ i} + {2}^{( k - p )} \cdot {\sum }_{i = 0}^{{2}^{x} - 1} {IA}_{xb \_ i} \cdot {W}_{b \_ x b [ x - 1 : ( x - ( k - p ) ] \_ i} \qquad ( 14 )$$

Where x: operation bit, k is the bit depth of cells 402 (x≥k), and p is the number of truncated (zeroed) bits (k≥p) (e.g., L−H).

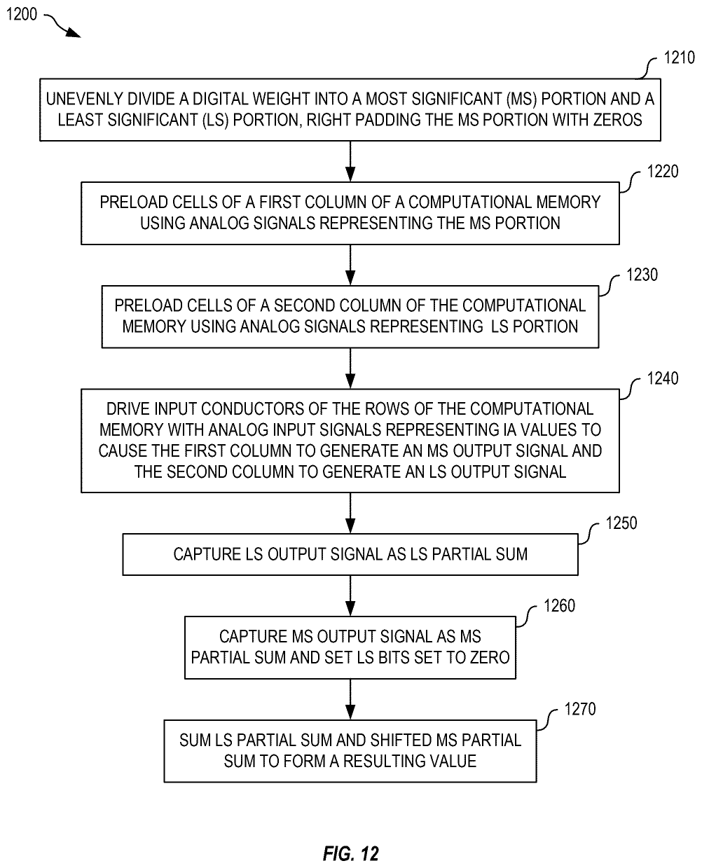

FIG. 12 is a flowchart illustrating one example noise reduction method 1200 for mixed in-memory computing, in embodiments. Method 1200 is implemented in part by control circuitry 1008 of computational memory 1000 of FIG. 10, for example.

At block 1210, method 1200 unevenly divides a digital weight into an MS portion and an LS portion, right padding the MS portion with zeros. In one example of block 1210, control circuitry 1008 splits digital weight 1102 into LS portion 1104 and MS portion 1106, where digital weight 1102 has eight-bits, LS portion 1104 has five-bits and is set to the five LS-bits of digital weight 1102 and MS portion 1106 has five-bits, where the three MS bits of MS portion 1106 are set to the three MS-bits of digital weight 1102 and the two LS bits of MS portion 1106 are set to zeros. In certain embodiments, block 1210 is implemented external to control circuitry 1008. At block 1220, method 1200 preloads cells of a first column of the computational memory using an analog signals representing the MS portion. In one example of block 1220, control circuitry 1008 controls input peripheral circuit 1010 to preload cells 402(1,0), 402(1,1), and so on, with an analog signals representing MS portion 1106. At block 1230, method 1200 preloads a second cell of a second column of the computational memory using an analog signal representing the LS portion. In one example of block 1230, control circuitry 1008 controls input peripheral circuit 1010 to preload cells 402(2,0), 402(2,1), and so on, with an analog signals representing LS portion 1104.

At block 1240, method 1200 drives input conductors of the rows of the computational memory with analog input signals representing IA values to cause the first column to generate an MS output signal and the second column to generate an LS output signal. In one example of block 1240, control circuitry 1008 controls input peripheral circuit 1010 to drive input conductor 416(1) with an analog input signal representative of IA0[7:0], input conductor 416(2) with an analog input signal representative of IA1[7:0], and so on, causing column 422(1) to generate MS output signal 1128 on output conductor 418(1) and causing column 422(2) to simultaneously generate LS output signal 1126 on output conductor 418(2). At block 1250, method 1200 captures LS output signal as LS partial sum. In one example of block 1250, control circuitry 1008 controls output peripheral circuit 1012 to capture MS partial sum 1116 from output conductor 418(1). At block 1260, method 1200 captures MS output signal as MS partial sum and sets LS bits set to zero. In one example of block 1260, control circuitry 1008 controls output peripheral circuit 1012 to capture MS output signal 1128 as MS partial sum 1116, and sets the two LS-bits of MS partial sum 1116 to zero.

At block 1270, method 1200 sums the LS partial sum and shifted MS partial sum to form a resulting value. In one example of block 1270, control circuitry 1008 controls logic operation unit 1056 to shift MS partial sum 1116 left by three bits and to sum the shifted MS partial sum 1116 with LS partial sum 1114 to generate resulting value 1120.

### Embodiment B—Input Bit-Slicing

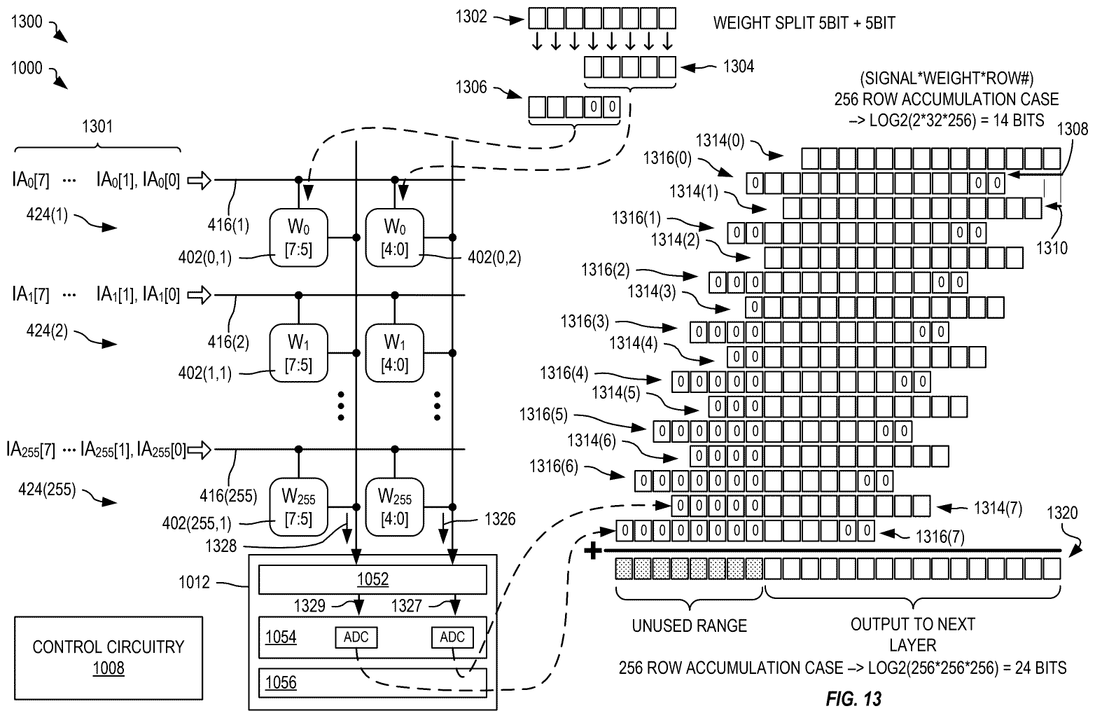

FIG. 13 is a schematic diagram illustrating example operation of computational memory 1000 of FIG. 10 with noise reduction 1300 when IA values are bit-sliced 1301, in embodiments. FIGS. 10 and 13 are best viewed together with the following description. In this example, each digital multiplier is eight-bits (e.g., shown as a digital weight 1302 representing weight W₀ of DNN 300) that is divided into an LS portion 1304 having the five LS-bits of digital weight 1302 and an MS portion 1306 having five bits, where the three MS-bits of MS portion 1306 are set to the three MS-bits of digital weight 1302, and the two LS-bits of MS portion 1306 are set to zeros. In this embodiment, both LS portion 1304 and MS portion 1306 are each five bits. The dividing of the digital weight and forming of MS portion 1306 may occur external to control circuitry 1008.

As described above for FIG. 9, input bit-slicing causes each IA bit to be input at a different sequential processing cycle (e.g., j is 0−(P−1) where P is the number of bits in the IA) of computational memory 1000, such that each processing cycle generates one MS output signal 1328 and one LS output signal 1326 for each input bit of IA.

In this example, the number of rows 424(N) in each column is 256, IA values are eight-bit and are bit-sliced and input to respective rows of computational memory 1000 one bit at a time. Accordingly, each LS partial sum 1314 and MS partial sum 1316 requires fourteen-bits (e.g., log₂(2×32×256)). Resulting value 1320 requires twenty-four-bits (e.g., similar to resulting value 1120 of FIG. 11) to accommodate the summation, after shifting, of LS partial sums 1314(0) and MS partial sums 1316 for each bit of IA input.

Continuing with the example of FIG. 13, since the two LS-bits of MS portion 1306 are set to zero, the two LS bits of each MS partial sum 1316 are also set to zero, thereby reducing noise in MS partial sum 1316 without loss of information and propagation of the noise to other layers of DNN 300 is reduced.

As shown in FIG. 13, (similar to the example of FIG. 9), for summation of LS partial sums 1314 and MS partial sums 1316, an MS shift 1308 applies a three-bit left shift of MS partial sum 1316 relative to LS partial sum 1314 and IA-bit shift 1310 applies a one bit left-shift of each corresponding pair of LS partial sum 1314 and MS partial sum 1316 based on the input IA-bit position (e.g., the current cycle j). This results in an effective one-bit left shift of each pair of LS partial sum 1314 and MS partial sum 1316 relative to those of the previous cycle, thereby accommodating the significance in the position of the IA bit being input for that cycle. For example, no shift is performed on LS partial sum 1314(0) and MS partial sum 1316(0) for cycle j=0; LS partial sum 1314(1) and MS partial sum 1316(1) are each shifted left by one bit (e.g., see IA-bit shifting 1310) for cycle j=1; LS partial sum 1314 (2) and MS partial sum 1316 (2) are each further shifted left by one-bit for cycle j=2; and so on. In one example of operation, control circuitry 1008 implements MS shift 1308 by controlling variable analog gain module 1052 to implement a gain of 2⁸ to MS output signal 1328 to form MS adjusted signal 1329, prior to capturing MS adjusted signal 1329 as MS partial sum 1316 using ADCs 1054. Similarly, control circuitry 1008 implements IA-bit shifting 1310 by controlling variable analog gain module 1052 to implement a gain of 2ⁱ to MS output signal 1328 to form MS adjusted signal 1329 and to LS output signal 1326 to form LS adjusted signal 1327, prior to capturing MS adjusted signal 1329 as MS partial sum 1316 and LS adjusted signal 1327 as LS partial sum 1314 using ADCs 1054.

After processing each cycle j of the IA, control circuitry 1008 then control logic operation unit 1056 to sum LS partial sum 1314 and MS partial sum 1316 to generate resulting value 1320. In this example, the MS byte (e.g., eight bits) of resulting value 1320 represents an unused range, and the remaining sixteen bits form an output to a next layer of DNN 300. As described in the following embodiments, MS shift 1308 and/or IA-bit shifting 1310 may be performed in either the analog domain (e.g., by control of variable analog gain module 1052 to apply a scaling-factor to the analog output signals) or in the digital domain (e.g., by control of logic operation unit 1056).

Equation (15) illustrates the calculation performed by computational memory 1000 to determine y₀ for this embodiment.

$${y}_{0} = {\sum }_{j = 0}^{8 - 1} {2}^{j} \cdot ( {\sum }_{i = 0}^{{2}^{8} - 1} {IA}_{8 {b}_{-} i} [ j ] \cdot {W}_{a \_ 8 b [ 4 : 0 ] \_ i} + {2}^{5 - 2} \cdot {\sum }_{i = 0}^{{2}^{8} - 1} {IA}_{8 {b}_{-} i} [ j ] \cdot {W}_{b \_ 8 b [ 7 : 5 ] \_ i} ) \qquad ( 15 )$$

The following equations illustrate the calculation of each partial sum, where i represents the cycle (e.g., bit position 0-7) if the bit slicing of AI and j represents the row being input. Each LS partial sum 1314 is calculated as using equation (16), and each MS partial sum 1316 is calculated using equation (17).

$$LS Partial Sum = {\sum }_{i = 0}^{{2}^{8} - 1} {IA}_{8 {b}_{-} i} [ j ] \cdot {W}_{a \_ 8 b [ 4 : 0 ] \_ i} \qquad ( 16 )$$

$$MS Partial Sum = {\sum }_{i = 0}^{{2}^{8} - 1} {IA}_{8 {b}_{-} i} [ j ] \cdot {W}_{a \_ 8 b [ 7 : 5 ] \_ i} \qquad ( 17 )$$

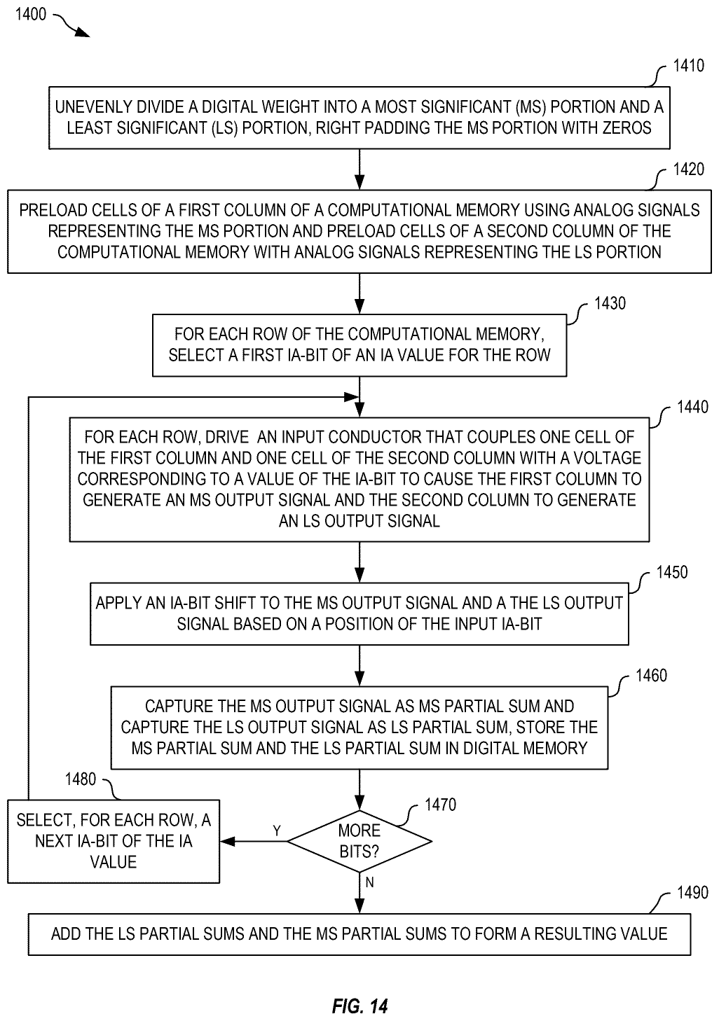

FIG. 14 is a flowchart illustrating one example noise reduction method 1400 for mixed in-memory computing with bit-slicing to input IA, in embodiments. Method 1400 is implemented in part by control circuitry 1008 of computational memory 1000 of FIG. 10, for example.

At block 1410, method 1400 unevenly divides a digital multiplier into an MS portion and an LS portion. In one example of block 1410, control circuitry 1008 splits digital weight 1302 into LS portion 1304 and MS portion 1306, where digital weight 1302 is eight bits, LS portion 1304 has five bits and is set to the five LS-bits of digital weight 1302 and MS portion 1306 has five bits, where the three MS-bits of MS portion 1306 are set to the three MS-bits of digital weight 1302 and the two LS-bits of MS portion 1306 are set to zeros, repeating for other weights. In certain embodiments, block 1410 is implemented external to control circuitry 1008. At block 1420, method 1400 preloads cells of a first column of a computational memory using analog signals representing the MS portion and preload cells of a second column of the computational memory with analog signals representing the LS portion. In one example of block 1420, control circuitry 1008 controls input peripheral circuit 1010 to preload cell 402(1,0) with an analog signal representing MS portion 1306, and to preload cell 402(0,2) with an analog signal representing LS portion 1304. At block 1430, for each row of the computational memory, method 1400 selects a first IA-bit of an IA value for the row. In one example of block 1430, control circuitry 1008 controls input peripheral circuit 1010 to select IA₀[0] as an AI-bit for row 424(1), to select IA₁[0] as an AI-bit for row 424(2), and so on.

At block 1440, for each row, method 1400 drives an input conductor that couples one cell of the first column and one cell of the second column with a voltage corresponding to a value of the IA-bit to cause the first column to generate an MS output signal and the second column to generate an LS output signal. In one example of block 1440, control circuitry 1008 controls input peripheral circuit 1010 to drive input conductor 416(1) with a first reference voltage (e.g., zero volts) when a value of IA0[0] is zero and to drive input conductor 416(1) with a second reference voltage (e.g., one volt) when the value of IA0[0] is one, repeating for other rows 424. These reference voltages may be any voltage between zero and the supply voltage (e.g., greater than zero and less than three volts).

Although block 1450 is shown before block 1460, block 1450 may occur after or within block 1460. At block 1450, method 1400 applies an AI-bit shift to the MS output signal and the LS output signal based on a position of the input IA-bit. In one example of block 1450, where block 1450 occurs before block 1460, control circuitry 1008 controls variable analog gain module 1052 to apply a gain of 2^{j} to each of MS output signal 1328 and LS output signal 1326. In another example of block 1450, where block 1450 occurs after or within block 1460, control circuitry 1008 controls logic operation unit 1056 to apply IA-bit shifting 1310 to each LS partial sum 1314 and MS partial sum 1316 when stored in the digital memory of logic operation unit 1056.

At block 1460, method 1400 captures the MS output signal as MS partial sum and captures the LS output signal as LS partial sum, storing the MS partial sum and the LS partial sum in digital memory. In one example of block 1460, control circuitry 1008 controls ADCs 1054 to capture MS partial sum 1316 from MS output signal 1328 on output conductor 418(1) and controls ADCs 1054 to capture LS partial sum 1314 from LS output signal 1326 on output conductor 418(2) and controls ADCs 1054 to capture LS partial sum 1314 from LS output signal 1326 on output conductor 418(2), storing MS partial sum 1316 and LS partial sum 1314 in memory of logic operation unit 1056.

Block 1470 is a decision. If, in block 1470, method 1400 determines that there are more bits of the IA to input, method 1400 continues with block 1480; otherwise, method 1400 continues with block 1490. In block 1480, for each row, method 1400 selects a next IA-bit of the IA value. In one example of block 1480, control circuitry 1008 controls input peripheral circuit 1010 to select IA₀[1] as a next IA-bit after IA₀[0] for input to row 424(1), to select IA₁[1] as IA-bit for input to row 424(2), and so on. Method 1400 then continues with block 1440. Blocks 1440 through 1480 repeat for each bit of the IA values being input.

At block 1490, method 1400 adds the LS partial sum and the MS partial sum to form a resulting value. In one example of block 1490, control circuitry 1008 controls logic operation unit 1056 to add MS partial sums 1316(0)-(7) to LS partial sums 1314(0)-(7) to form resulting value 1120, where resulting value 1320 forms an output to a next layer of DNN 300. Method 1400 repeats for each pair of columns that generate an output to the next layer of DNN 300.

### 1^{st} Embodiment

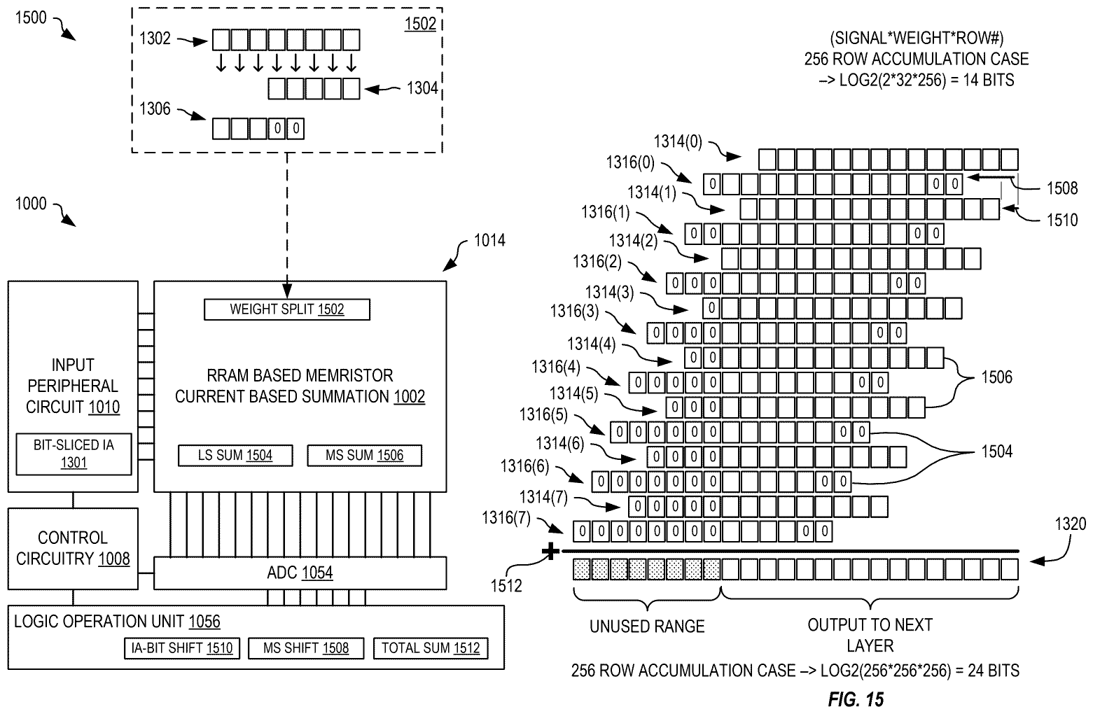

FIG. 15 shows one example implementation 1500 of computational memory 1000 of FIG. 10 with noise reduction 1300 of FIG. 13 when IA values are bit-sliced 1301 and where MS shifting 1508, IA-bit shifting 1510, and total summing 1512 are performed in the digital domain, in embodiments.

In operation, implementation 1500 follows the example of noise reduction 1300 of FIG. 13. Weight splitting 1502 represents the splitting of digital weight 1302 into LS portion 1304 and MS portion 1306, which are preloaded as analog signals into RRAM 1002 as described above. Accordingly, weight splitting 1502 is shown within RRAM 1002. LS summing 1504 and MS summing 1506 represent MAC calculations performed by two columns 422 of RRAM 1002 and are shown within RRAM 1002.

MS shifting 1508, and IA-bit shifting 1510 are implemented in the digital domain by logic operation unit 1056. Logic operation unit 1056 shifts MS partial sums 1316 left by three-bits (see MS shifting 1508) relative to LS partial sum 1314, and both LS partial sum 1314 and MS partial sum 1316 are shifted left (IA-bit shifting 1510) according to the current cycle j, as illustrated in FIG. 15.

Total summing 1512 represents the summing of LS partial sums 1314 and MS partial sums 1316 to form resulting value 1320 and is performed by logic operation unit 1056. In certain embodiments, operations of MS shifting 1508, IA-bit shifting 1510, and total summing 1512 are combined. For example, MS shifting 1508 and IA-bit shifting 1510 may be implemented by left-shift operations on LS partial sum 1314 and MS partial sum 1316 after capture by ADCs 1054. Total summing 1512 may be performed incrementally at the end of each input cycle or may be performed at the completion of the last cycle.

The eight MS-bits of resulting value 1320 are unused, the remaining sixteen LS-bits of resulting value 1320 are output for use in subsequent layers of DNN 300.

### 2^{nd} Embodiment

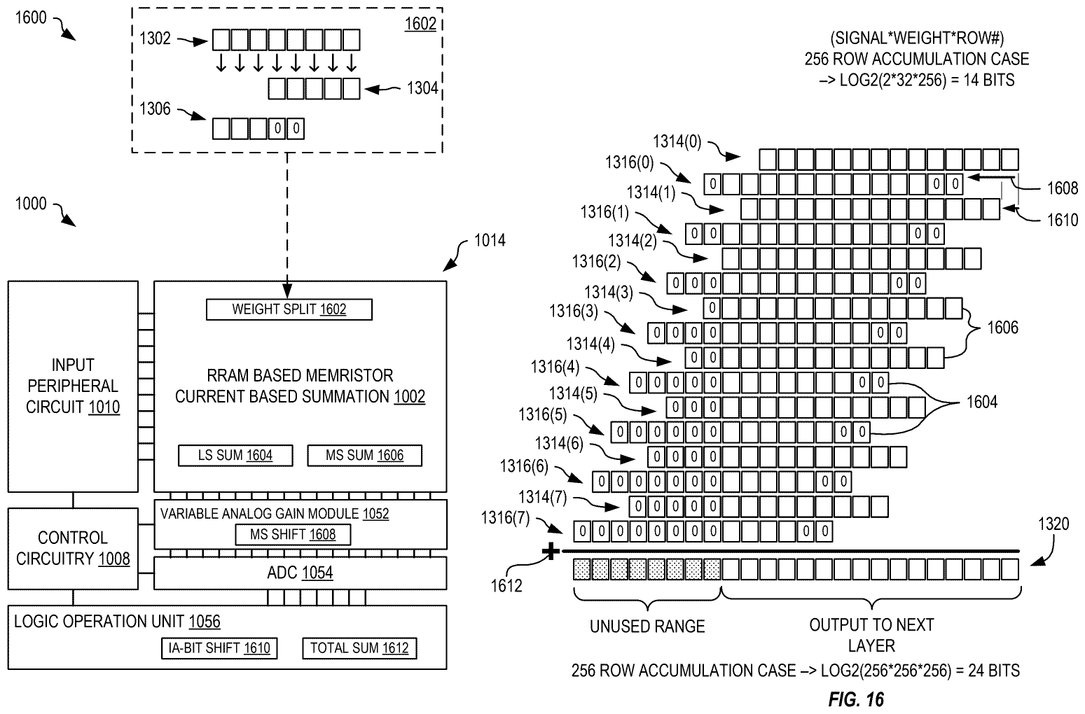

FIG. 16 shows one example implementation 1600 of computational memory 1000 of FIG. 10 with noise reduction 1300 of FIG. 13 when IA values are bit-sliced 1301, where MS shifting 1608 is performed by variable analog gain module 1052 (e.g., in the analog domain), and where IA-bit shifting 1610 and total summing 1612 are performed in logic operation unit 1056 (e.g., the digital domain), in embodiments. MS shifting 1608 represents the multiplication of the MS partial sum by a scaling-factor of 2 to the power (L−(L−H)), as described above for FIG. 13. In one example of operation, each weight 306 of DNN 300 is divided unevenly into LS portion 1304 and MS portion 1306 as described above and RRAM 1002 is preloaded with the split weights, indicated as weight splits 1602 in RRAM 1002. Control circuitry 1008 controls input peripheral circuit 1010 to input IA values one bit per cycle that causes RRAM 1002, for each cycle, to concurrently perform LS summing 1604 and MS summing 1606. Control circuitry 1008 controls variable analog gain module 1052 to perform MS shifting 1608 of MS partial sum 1316 and then controls ADCs 1054 to capture LS partial sum 1314 and MS partial sum 1316 for each IA bit. Control circuitry 1008 then controls logic operation unit 1056 to perform IA-bit shifting 1610, storing the shifted LS partial sum 1314 and MS partial sum 1316 for each cycle. At a final cycle (e.g., when a last bit of IA is input), control circuitry 1008 controls logic operation unit 1056 to perform total summing 1612 of the stored (and shifted) partial sums 1314 and 1316 to generate resulting value 1320. Particularly, IA-bit shifting 1610, and total summing 1612 are performed in the digital domain and LS summing 1604, MS summing 1606, and MS shifting 1608 are performed in the analog domain.

### 3^{rd} Embodiment

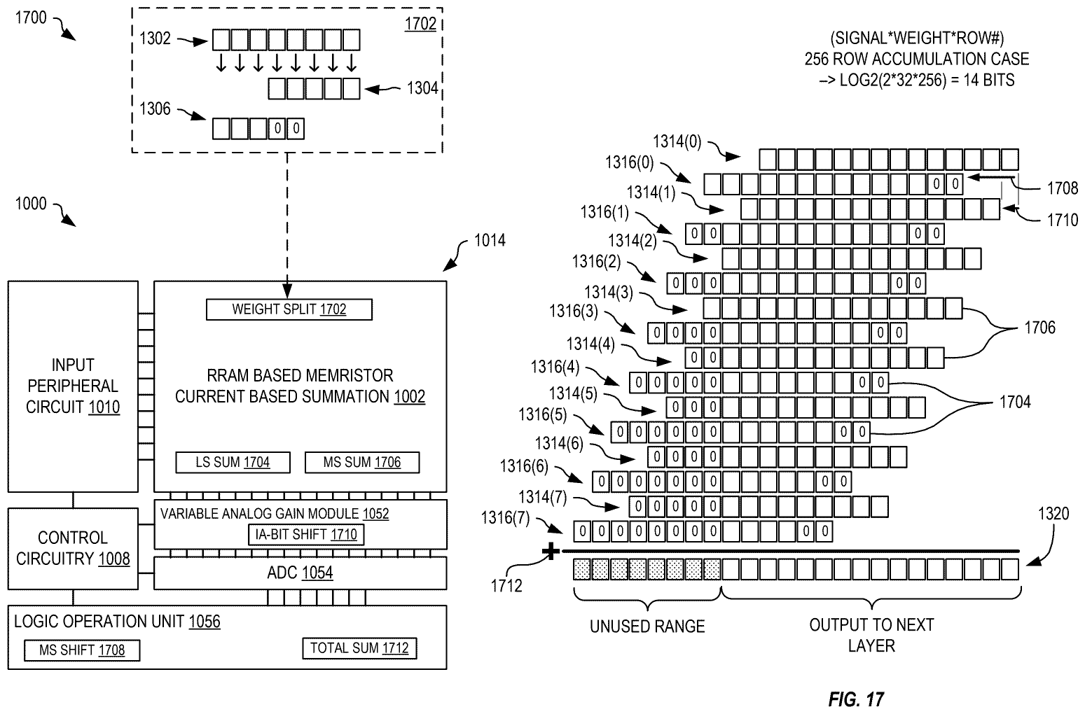

FIG. 17 shows one example implementation 1700 of computational memory 1000 of FIG. 10 with noise reduction 1300 of FIG. 13 when IA values are bit-sliced 1301, where IA-bit shifting 1710 is performed by variable analog gain module 1052 (e.g., in the analog domain), and where MS shifting 1708 and final summing 1712 are performed in logic operation unit 1056 (e.g., the digital domain), in embodiments. MS shifting 1708 represents the multiplication of the MS partial sum by 2 to the power (L−(L−H)), as described above for FIG. 13. In one example of operation, each weight 306 of DNN 300 is divided unevenly into LS portion 1304 and MS portion 1306 as described above and RRAM 1002 is preloaded with the split weights, indicated as weight splits 1702 in RRAM 1002. Control circuitry 1008 controls input peripheral circuit 1010 to input IA values one bit per cycle that causes RRAM 1002, for each cycle, to concurrently calculate one LS partial sum 1704 and one MS partial sum 1706. Control circuitry 1008 controls variable analog gain module 1052 to perform IA-bit shifting 1710 of LS partial sum 1314 and MS partial sum 1316, controls ADCs 1054 to capture LS partial sum 1314 and MS partial sum 1316 for each IA bit, and controls logic operation unit 1056 to perform MS shifting 1708 for each MS partial sum 1316, and zeros LS bits of each MS partial sum 1316 as needed, storing the shifted LS partial sum 1314 and MS partial sum 1316 for each cycle. For example, in the first cycle (j=0), since IA-bit shifting 1710 is applied to MS output signal 1328 in the analog domain, after capture of MS output signal 1328 by ADCs 1054, two LS bits of MS partial sum 1316(0) are zeroed. In the second cycle (j=1), three LS bits of MS partial sum 1316(1) are zeroed and one LS bit of LS partial sum 1314(1) is zeroed, and so on.

At a final cycle (e.g., when a last bit of IA is input), control circuitry 1008 controls logic operation unit 1056 to perform a total sum 1712 of the stored partial sums 1314 and 1316 to generate resulting value 1320.

### 4^{th} Embodiment

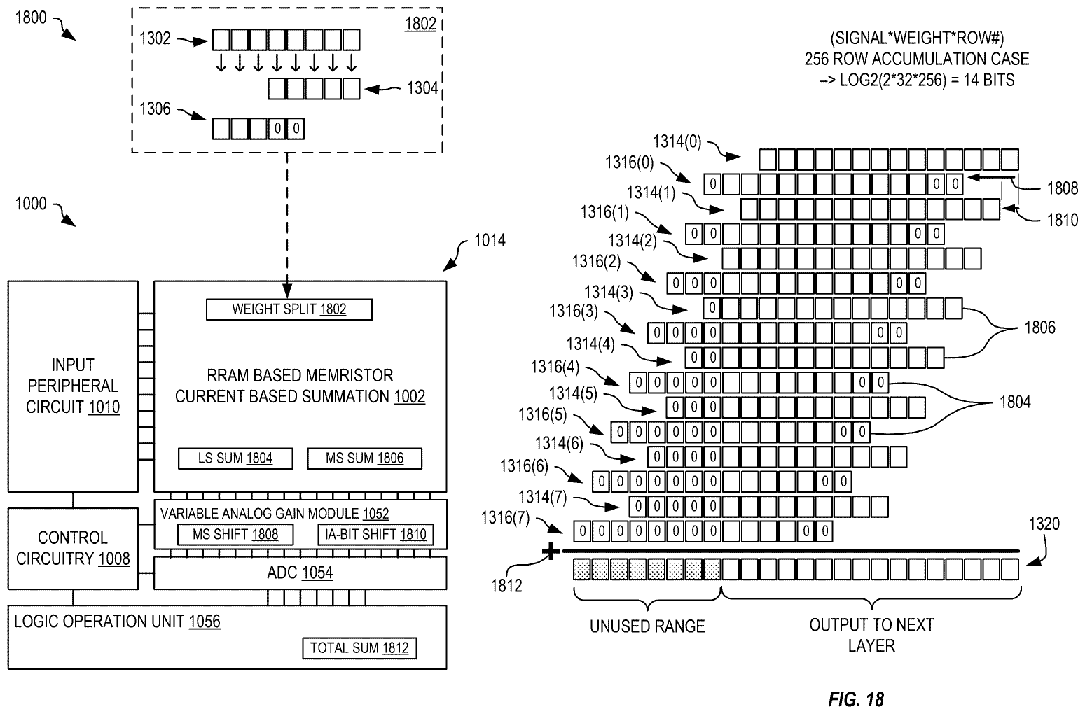

FIG. 18 shows one example implementation 1800 of computational memory 1000 of FIG. 10 with noise reduction 1300 of FIG. 13 when IA values are bit-sliced 1301, where MS shifting 1808 and IA-bit shifting 1810 are performed by variable analog gain module 1052 (e.g., in the analog domain), and where final summing 1812 is performed in logic operation unit 1056 (e.g., the digital domain), in embodiments. MS shifting 1808 represents the multiplication of the MS partial sum by a scaling-factor of 2 to the power (L−(L−H)), as described above for FIG. 13. In one example of operation, each weight 306 of DNN 300 is divided unevenly into LS portion 1304 and MS portion 1306 as described above and RRAM 1002 is preloaded with the split weights, indicated as weight splits 1802 in RRAM 1002. Control circuitry 1008 controls input peripheral circuit 1010 to input IA values one bit per cycle that causes RRAM 1002, for each cycle, to concurrently calculate one LS partial sum 1804 and one MS partial sum 1806. Control circuitry 1008 controls variable analog gain module 1052 to perform MS shifting 1808 of MS partial sum 1316 and an IA-bit shifting 1810 of LS partial sum 1314 and MS partial sum 1316, controls ADCs 1054 to capture LS partial sum 1314 and MS partial sum 1316 for each IA bit, and controls logic operation unit 1056 to store the shifted LS partial sum 1314 and MS partial sum 1316 for each cycle. For example, in the first cycle (j=0), since IA-bit shifting 1810 is not required but MS shifting 1808 is applied to MS output signal 1328 in the analog domain, after capture of MS output signal 1328 by ADCs 1054, five LS bits of MS partial sum 1316(0) are zeroed. In the second cycle (j=1), IA-bit shifting 1810 applies a gain of two to each of LS output signal 1326 and MS output signal 1328, and MS shifting 1808 applies a further gain of 2^{(L-(L-H))} (e.g., eight) to MS output signal 1328. Accordingly, six LS bits of MS partial sum 1316(1) are zeroed and one LS bit of LS partial sum 1314(1) is zeroed. In the third cycle, (j=2), IA-bit shifting 1810 applies a gain of four to each of LS output signal 1326 and MS output signal 1328, and MS shifting 1808 applies a further gain of 2^{(L-(L-H))} (e.g., eight) to MS output signal 1328. Accordingly, seven LS bits of MS partial sum 1316(1) are zeroed and two LS bit of LS partial sum 1314(1) are zeroed, and so on.

At a final cycle (e.g., when a last bit of IA is input), control circuitry 1008 controls logic operation unit 1056 to perform a total sum 1812 of the stored partial sums 1314 and 1316 to generate resulting value 1320.

### 5^{th} Embodiment

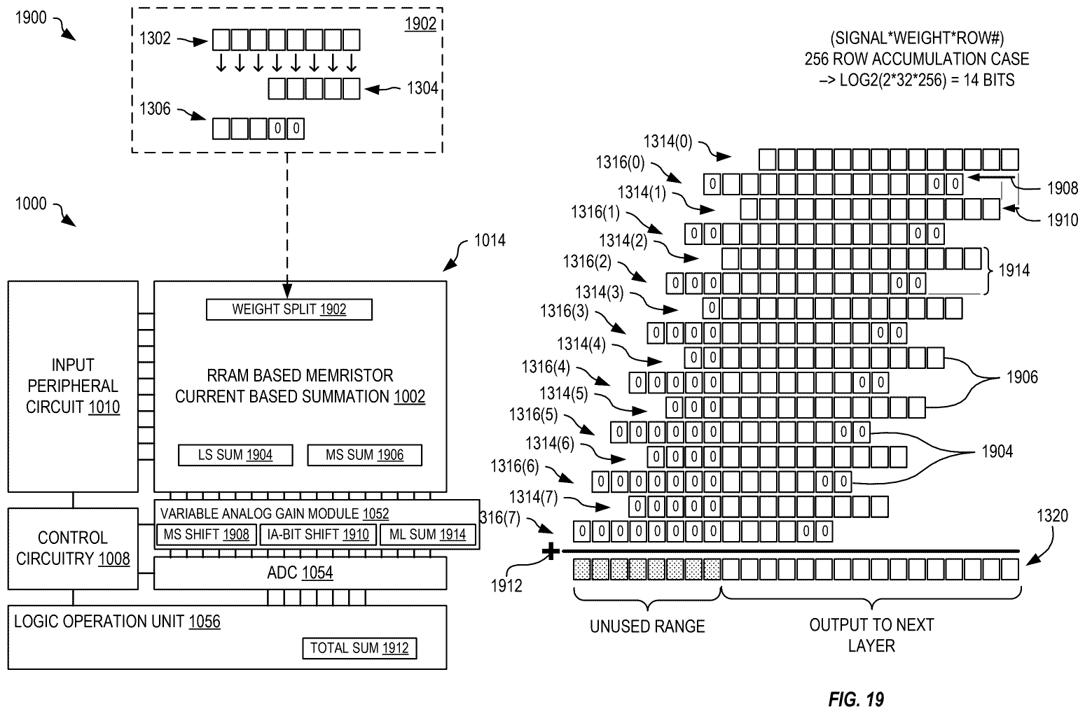

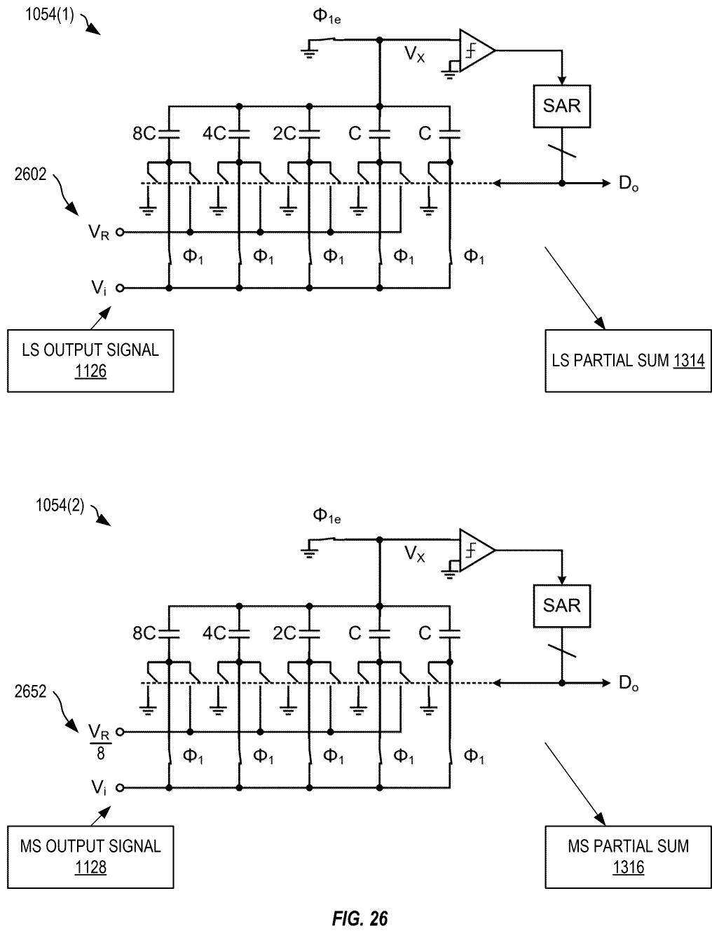

FIG. 19 shows one example implementation 1900 of computational memory 1000 of FIG. 10 with noise reduction 1300 of FIG. 13 when IA values are bit-sliced 1301, where MS shifting 1908, IA-bit shifting 1910, and most and least (ML) summing 1914 are performed by variable analog gain module 1052 (e.g., in the analog domain), and where final summing 1912 is performed in logic operation unit 1056 (e.g., the digital domain), in embodiments. MS shifting 1908 represents the multiplication of the MS partial sum by a scaling-factor of 2 to the power (L−(L−H)), as described above for FIG. 13. In one example of operation, each weight 306 of DNN 300 is divided unevenly into LS portion 1304 and MS portion 1306 as described above and RRAM 1002 is preloaded with the split weights, indicated as weight splits 1902 in RRAM 1002. Control circuitry 1008 controls input peripheral circuit 1010 to input IA values one bit per cycle that causes RRAM 1002, for each cycle, to concurrently calculate one LS partial sum 1904 and one MS partial sum 1906. Control circuitry 1008 controls variable analog gain module 1052 to perform MS shifting 1908 of MS partial sum 1316. In certain embodiments, MS shifting 1908 is implemented by applying a gain to a reference signal of as shown in FIG. 26. In other embodiments, MS shifting 1908 is implemented by applying a gain to MS output signal 1328. Control circuitry 1008 also controls variable analog gain module 1052 to perform an IA-bit shift 1910 of LS partial sum 1314 and MS partial sum 1316, and to perform ML summing 1914 of LS partial sum 1314 and MS partial sum 1316. That is, LS partial sums 1314 and 1316 are summed after shifting. Control circuitry 1008 controls ADCs 1054 to capture ML summed 1914 value for each IA bit, and controls logic operation unit 1056 to store ML summed 1914 value for each cycle. For example, in the first cycle (j=0), IA-bit shifting 1810 is not applied, MS shifting 1808 applies a gain of 2^{(L-(L-H))} (e.g., eight) to MS output signal 1328, and control circuitry 1008 controls variable analog gain module 1052 to sum LS output signal 1326 and MS output signal 1328, controls ADCs 1054 to capture the summed signal, which is stored in memory of logic operation unit 1056. In the second cycle (j=1), IA-bit shifting 1810 applies a gain of two to each of LS output signal 1326 and MS output signal 1328, MS shifting 1808 applies a further gain of 2^{(L-(L-H))} (e.g., eight) to MS output signal 1328, and control circuitry 1008 controls variable analog gain module 1052 to sum LS output signal 1326 and MS output signal 1328. In the third cycle (j=2), IA-bit shifting 1810 applies a gain of four to each of LS output signal 1326 and MS output signal 1328, MS shifting 1808 applies a further gain of 2^{(L-(L-H))} (e.g., eight) to MS output signal 1328, and control circuitry 1008 controls variable analog gain module 1052 to sum LS output signal 1326 and MS output signal 1328, and so on.

At a final cycle (e.g., when a last bit of IA is input), control circuitry 1008 controls logic operation unit 1056 to perform a total sum 1912 of the stored ML summing 1914 values to generate resulting value 1320.

### 6^{th} Embodiment

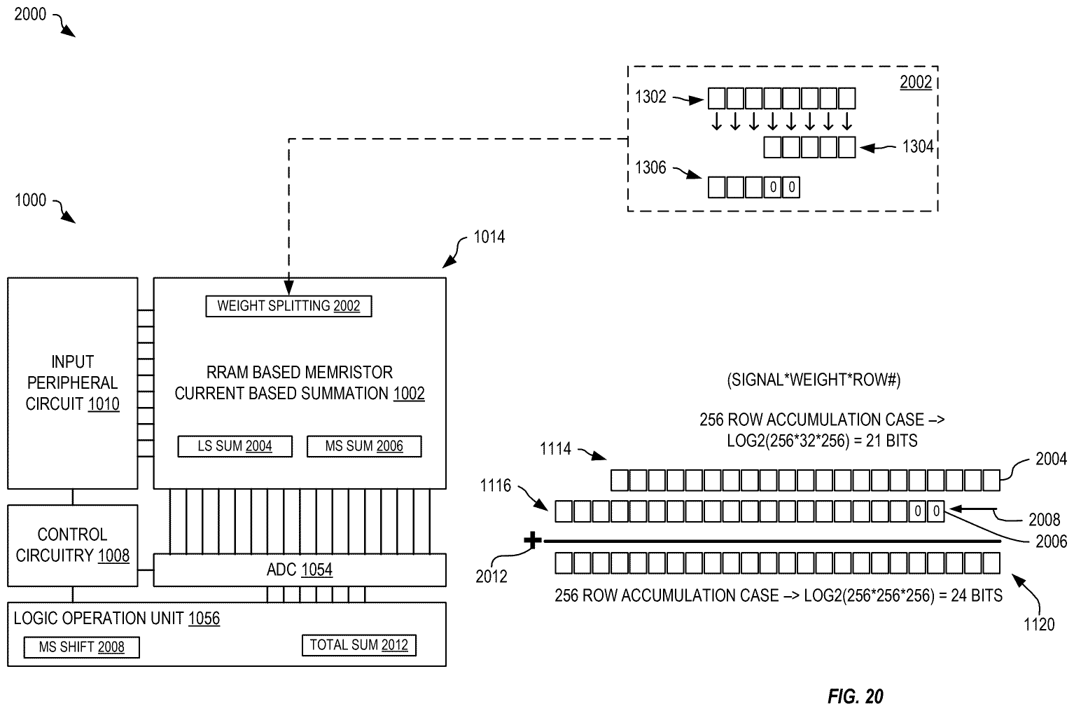

FIG. 20 shows one example implementation 2000 of computational memory 1000 of FIG. 10 with noise reduction 1100 of FIG. 11 when IA values are multi-bit, where MS summing 2006 and LS summing 2004 are performed within RRAM 1002 (e.g., in the analog domain), and where MS shifting 2008 and total summing 2012 are performed in logic operation unit 1056 (e.g., the digital domain), in embodiments. MS shifting 2008 represents the multiplication of the MS partial sum by 2 to the power (L−(L−H)), as described above for FIG. 11. In one example of operation, each weight 306 of DNN 300 is divided unevenly into LS portion 1304 and MS portion 1306 as described above and RRAM 1002 is preloaded with the split weights, indicated as weight splitting 2002 in RRAM 1002. Control circuitry 1008 controls input peripheral circuit 1010 to concurrently input analog signals representative of each IA value (e.g., values for IA₀, IA₁, etc. where each IA value is eight-bits converted to analog using a DAC of input peripheral circuit 1010) that causes RRAM 1002 to concurrently perform LS summing 2004 and MS summing 2006, generating LS output signal 1126 and MS output signal 1128, respectively. Control circuitry 1008 controls ADCs 1054 to capture LS output signal 1126 and MS output signal 1128 as LS partial sum 1114 and MS partial sum 1116, respectively. Control circuitry 1008 controls logic operation unit 1056 to perform MS shifting 2008 (e.g., three bit left shift) on MS partial sum 1116, and controls logic operation unit 1056 to perform total summing 2012 of the shifted MS partial sum 1116 and LS partial sum 1114.

### 7^{th} Embodiment

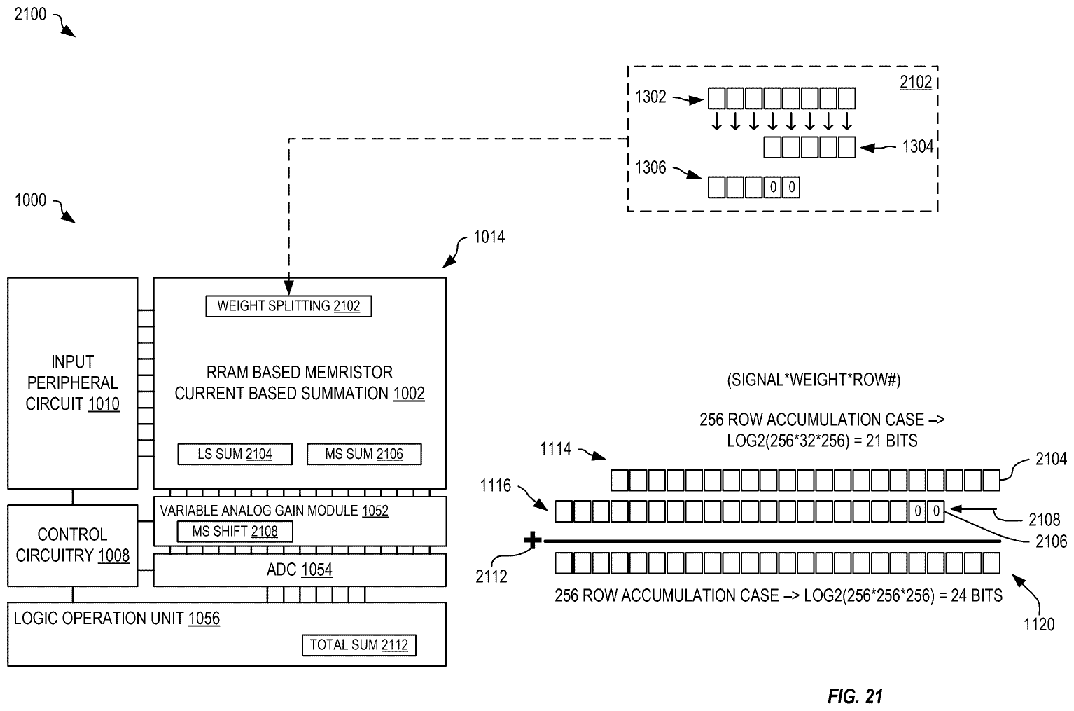

FIG. 21 shows one example implementation 2100 of computational memory 1000 of FIG. 10 with noise reduction 1100 of FIG. 11 when IA values are analog (e.g., multi-bit converted to an analog signal from a digital value by a DAC), where MS sum 2106 and LS summing 2104 are performed within RRAM 1002 (e.g., in the analog domain), where MS shifting 2108 is performed in variable analog gain module 1052, and where total summing 2112 is performed in logic operation unit 1056 (e.g., the digital domain), in embodiments. MS shifting 2108 represents the multiplication of the MS partial sum by a scaling-factor of 2 to the power (L−(L−H)), as described above for FIG. 11. In one example of operation, each weight 306 of DNN 300 is divided unevenly into LS portion 1304 and MS portion 1306 as described above and RRAM 1002 is preloaded with the split weights, indicated as weight splitting 2102 in RRAM 1002. Control circuitry 1008 controls input peripheral circuit 1010 to concurrently input analog signals representative of each IA value (e.g., values for IA0, IA1, etc. where each IA value is eight-bits converted to analog using a DAC of input peripheral circuit 1010) that causes RRAM 1002 to concurrently perform LS summing 2104 and MS summing 2106, generating LS output signal 1126 and MS output signal 1128, respectively. Control circuitry 1008 controls variable analog gain module 1052 to perform MS shifting 2108 (e.g., a gain of eight) on MS output signal 1128, and controls ADCs 1054 to capture LS output signal 1126 as LS partial sum 1114 and to capture MS output signal 1128 as MS partial sum 1116. Control circuitry 1008 may then control logic operation unit 1056 to zero LS bits of MS partial sum 1116, and then controls logic operation unit 1056 to perform total summing 2112 of MS partial sum 1116 and LS partial sum 1114 to form resulting value 1120.

### 8^{th} Embodiment

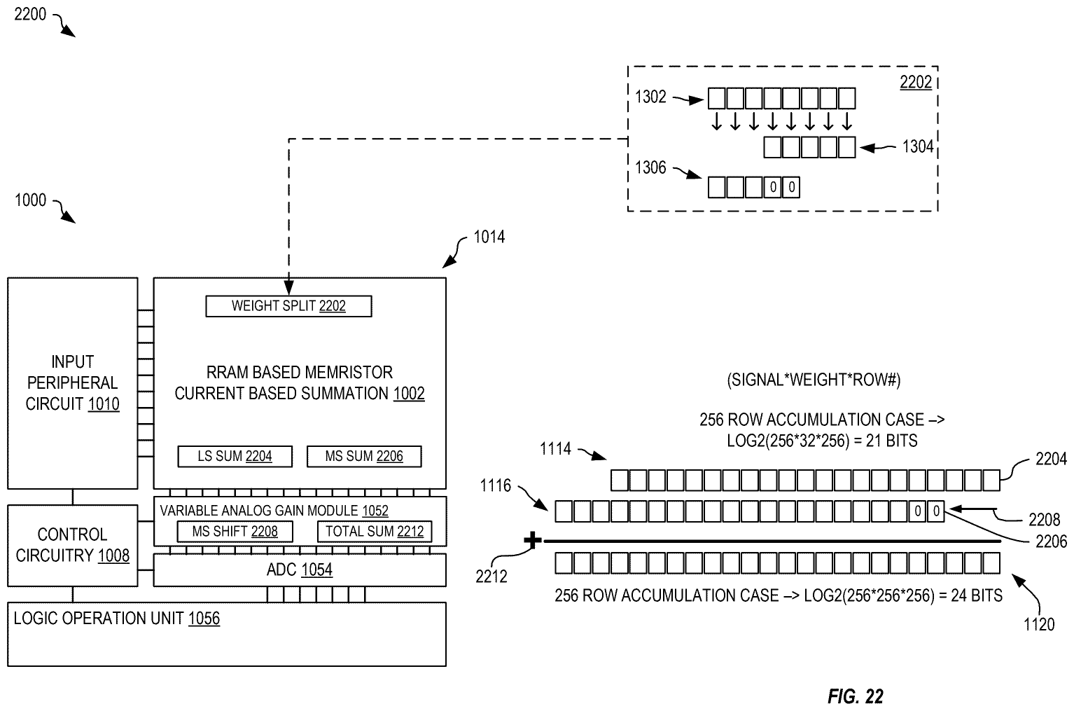

FIG. 22 shows one example implementation 2200 of computational memory 1000 of FIG. 10 with noise reduction 1100 of FIG. 11 when IA values are analog (e.g., multi-bit converted to an analog signal from a digital value by a DAC), where MS partial sum 1116 and LS partial sum 1114 are performed within RRAM 1002 (e.g., in the analog domain), and where MS shifting 2108 and total summing 2212 are performed in variable analog gain module 1052, in embodiments. MS shifting 2208 represents the multiplication of the MS partial sum by a scaling-factor of 2 to the power (L−(L−H)), as described above for FIG. 11. In one example of operation, each weight 306 of DNN 300 is divided unevenly into LS portion 1304 and MS portion 1306 as described above and RRAM 1002 is preloaded with the split weights, indicated as weight splits 2202 in RRAM 1002. Control circuitry 1008 controls input peripheral circuit 1010 to concurrently input analog signals representative of each IA value (e.g., values for IA₀, IA₁, etc. where each IA value is eight-bits converted to analog using a DAC of input peripheral circuit 1010) that causes RRAM 1002 to concurrently perform LS summing 2204 and MS summing 2206, generating LS output signal 1126 and MS output signal 1128, respectively. Control circuitry 1008 controls variable analog gain module 1052 to perform MS shifting 2208 (e.g., a gain of eight) on MS output signal 1128 to form MS adjusted signal 1129, and to perform total summing 2212 of MS adjusted signal 1129 and LS output signal 1126. Control circuitry 1008 then controls ADCs 1054 to capture the signal from total summing 2212 as resulting value 1120. FIG. 22 shows the two LS bits of MS partial sum 1116 as zero since, since the two LS bits of MS portion 1306 are zeroed. In this embodiment, all arithmetic functions are performed in the analog domain and no arithmetic is performed by logic operation unit 1056 in this embodiment.

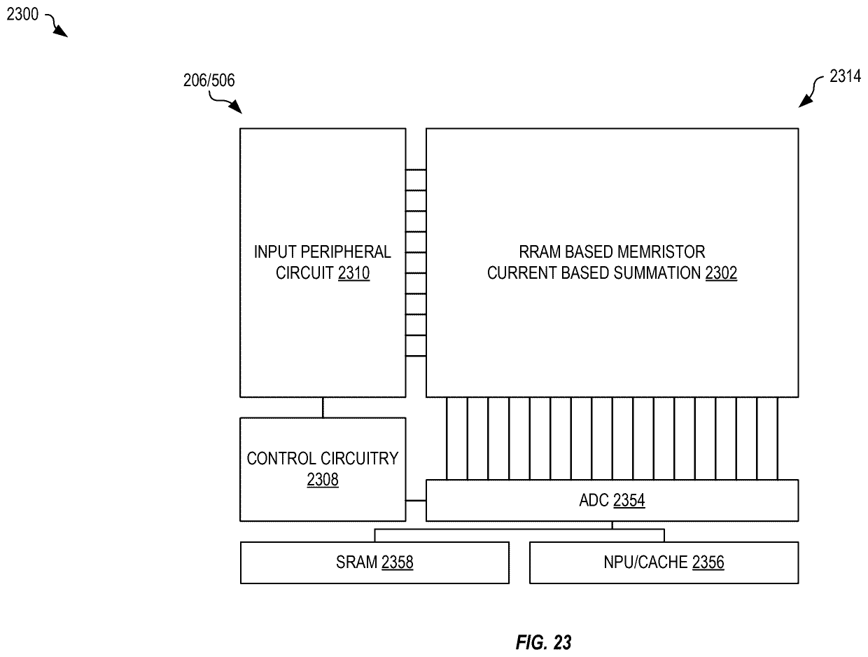

FIG. 23 is a schematic illustrating one example computer 2300 with weights stored in an RRAM 2302 (e.g., a cross-bar 2314 memristor array), in embodiments. Computer 2300 includes control circuitry 2308, an input peripheral circuitry 2310, an ADC 2354, a static random-access memory (SRAM) 2358, and a numerical processing unit (NPU) 2356 where NPU 2356 and SRAM 2358 are implemented in a convention von Neumann architecture. In this example, each memristor of RRAM 2302 stores a multi-bit weight (e.g., w₀, w₁, etc.) that each represent one weight 306 of DNN 300. IA values (e.g., IA₀, IA₁, etc.) for input to DNN 300 are stored as multibit values in SRAM 2358. In one example of operation, NPU 2356 directs control circuitry 2308 to input a weight to NPU 2356. In response, control circuitry 2308 controls input peripheral circuitry 2310 to cause RRAM 2302 to output an analog signal from at least one memristor to ADC 2354 and controls ADC 2354 to convert the analog signal to digital, where the digital value represents the weight. In certain embodiments, each weight may be stored by multiple memristors, thereby increasing range and/or resolution of the weight. Advantageously, since each memristor stores a multi-bit value whereas each SRAM cell only stored one bit, the number of memory locations required to store the weights in RRAM 2302 is significantly less that the number of locations requires to store the same values in SRAM 2358,

For example, as described above for weight split 1502 of FIG. 15, each digital weight may be split into MS portion 1306 and LS portion 1304, where each portion is stored in a different memristor. Any combination of multi-bit may be used. For example, where the digital weight is an eight bit value, LS weight portion may have five bits and MS weight portion may have 3 bits padded with two LS bits set to zero as described above. Where the computation performed by NPU 2356 is less concerned by LSB bit error, such as when performing multiplying and accumulation for a DNN, the SNR is improved, since MSB noise propagation is reduced by LSB zeroing during memristor programming.

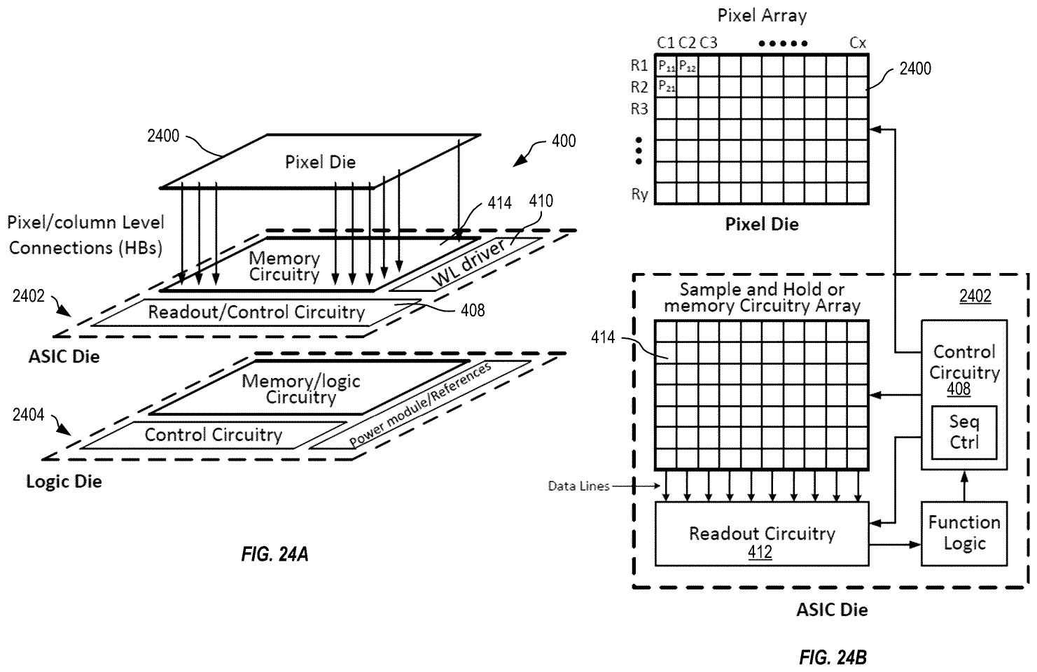

FIG. 24A is a schematic diagram illustrating one example integration of computational memory 400 of FIG. 4 with an image sensor 2400, in embodiments. FIG. 24B is a schematic diagram illustrating example functionality between image sensor 2400 and ASIC die 2402 of FIG. 24A, in embodiments. FIGS. 24A and 24B are best viewed together with the following description.

Computational memory 400 and image sensor 2400 may be electrically coupled through wafer-to-wafer hybrid bonding (HB) connectors on an ASIC die 2402. ASIC die 2402 may couple with a logic die 2404. A readout/control circuitry (e.g., control circuitry 408, FIG. 4, control circuitry 1008, FIG. 10) controls operation of cross-bar array 414 to process images captured by image sensor 2400 through DNN 300. For example, DNN 300 may implement inference of images captured by image sensor 2400. As shown in FIG. 24B, control circuitry 408 controls input of data from image sensor 2400 into cross-bar array 414 based on a sequence controller. Output peripheral circuits 412 convert the output of cross-bar array 414 into data used by a function logic and/or further processing elements, such as by memory circuits of a logic die 2404. Advantageously, image sensor 2400 and computational memory 400 are combined into a single device, effectively realizing AI functionality in sensor 2400. Further, in certain embodiments, the amount of data being sent from image sensor 2400 to a host device is reduced where the host device receives metadata from DNN 300 implemented by computational memory 400. Accordingly, the required data bandwidth between image sensor 2400 and the host is reduced and the computational work load on the host is also reduced.

Advantageously, by combining computational memory 400 with image sensor 2400, on-chip object classification or object identification may be implemented to detect one or more objects in the captured image based on a predefined set of objects stored in a memory (e.g., look up table) based on CNN output parameters. Although shows as two separate dies, functionality of the ASIC die and the logic die may be combined on a single die without departing from the scope hereof.

FIGS. 25A and 25B are schematic diagrams illustrating example stand alone modules 2500 and 2550 that may be switch into circuit by variable analog gain module 1052 of FIG. 10 to apply a gain to LS output signals 1126/1326 and/or MS output signal 1128/1328 of FIGS. 11 and 13, in embodiments. Module 2500 represents one example switched capacitor circuit and module 2550 represents one example R-2R ladder circuit. Other switched capacitor circuits and/or R-2R ladder circuits may be used without departing from the scope hereof. For example, variable analog gain module 1052 may include multiple modules 2500 and/or 2550 that are switch in and out of circuit with LS output signal 1126/1326 and/or MS output signal 1128/1328 as needed.

### Reference Adjustment For ADC Gain

FIG. 26 is a schematic illustrating example configuration of two ADCs 1054(1) and 1054(2) for capturing LS output signal 1326 as LS partial sum 1314 and MS output signal 1328 as a shifted MS partial sum 1316 prior to summing in the digital domain, in embodiments. Using the embodiment of FIG. 19, where MS shifting 1908 is implemented in the analog domain (e.g., by variable analog gain module 1052), ADC 1054(1) operates to capture LS output signal 1326 without shifting and ADC 1054(2) is configured to apply a left shift of three-bits to MS partial sum 1316 during capture. Control circuitry 1008 controls variable analog gain module 1052 to apply a gain of ⅛ to the reference voltage 2652 input to ADC 1054(2). The reference voltage 2602 input to ADC 1054(1) is unadjusted. Accordingly, ADC 1054(2) generates MS partial sum 1316 with an effective gain of 8 (e.g., a left shift of three-bits) relative to LS partial sum 1314. Control circuitry 1008 then controls logic operation unit 1056 to sum LS partial sum 1314 and MS partial sum 1316. Operation of ADC 1054(1) in this embodiments is defined by equations (18) and (19), respectively.

$${V}_{i} \cdot 16 C = ( {V}_{R} - {V}_{x} ) {C}_{4} - {V}_{x} ( {C}_{3} + {C}_{2} + {C}_{1} + {C}_{0} ) \qquad ( 18 )$$

$${V}_{x} = \frac{{V}_{R} \cdot 8 C - {V}_{i} \cdot 16 C}{16 C} = \frac{{V}_{R}}{2} - {V}_{i} \qquad ( 19 )$$

Operation of ADC 1054(2) in this embodiments is defined by equations (20) and (21), respectively.

$${V}_{i} \cdot 16 C = ( \frac{{V}_{R}}{8} - {V}_{x} ) {C}_{4} - {V}_{x} ( {C}_{3} + {C}_{2} + {C}_{1} + {C}_{0} ) \qquad ( 20 )$$

$${V}_{x} = \frac{\frac{{V}_{R}}{8} \cdot 8 C - {V}_{i} \cdot 16 C}{16 C} = \frac{{V}_{R}}{16} - {V}_{i} \qquad ( 21 )$$

### Cooperative ADC Summing

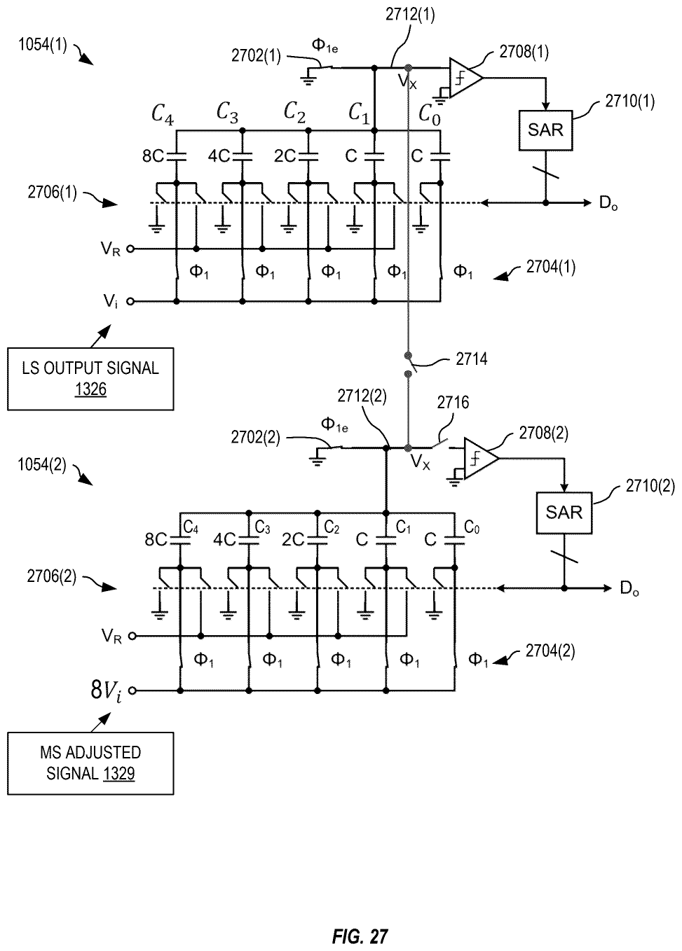

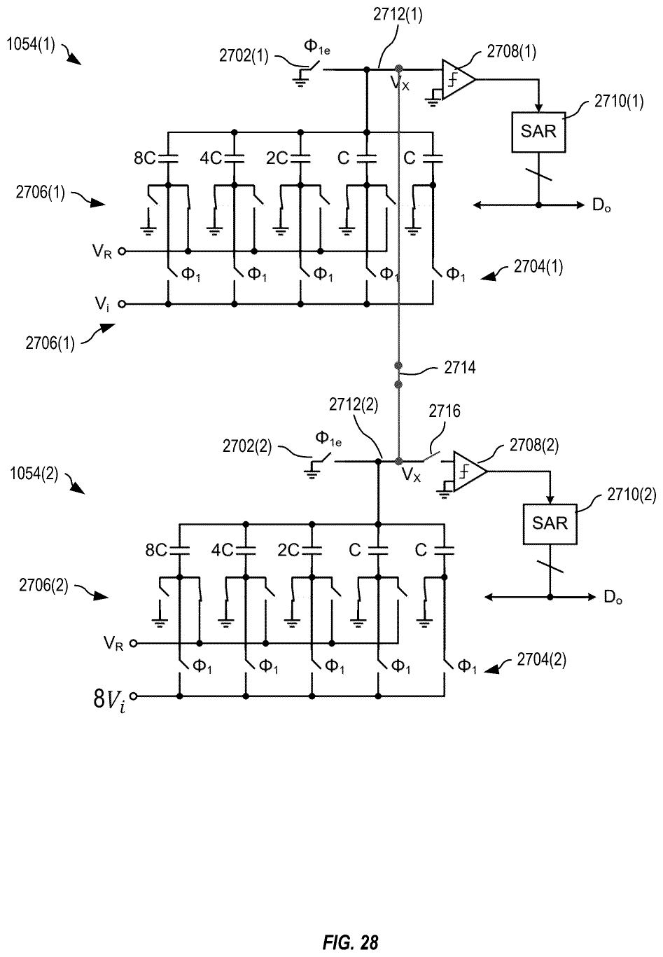

FIGS. 27 and 28 are schematic diagrams illustrating cooperation between two ADCs 1054(1) and 1054(2) to sum two analog values (e.g., LS output signal 1326 and MS adjusted signal 1329) during conversion to a digital value, in embodiment. In the following example, ADC 1054(1) receives input (e.g., as Vᵢ) of LS output signal 1326 (e.g., from column 422(2)) of noise reduction 1300 of FIG. 13 and ADC 1054(2) receives input (e.g., as Vᵢ) of MS adjusted signal 1329 (e.g., from column 422(1) after a gain of eight is applied by variable analog gain module 1052); however, ADC cooperation may equally apply to any pair of adjacent columns of computational memory 1000 that generate partial sums from splitting of the same digital weight. For example, ADC cooperation may also apply to columns 422(1) and 422(2) of noise reduction 1100 of FIG. 11 to sum LS output signal 1126 and MS adjusted signal 1129 to form resulting value 1120.

As shown in FIGS. 27 and 28, an input conductor 2712(1) of ADC 1054(1) is electrically coupled to an input conductor 2712(2) of ADC 1054 (2) via a switch 2714. Switch 2714 is open during the first acquisition phase (shown in FIG. 27) and input conductor 2712(2) is disconnected from comparator 2708(2) of ADC 1054(2) by a switch 2716. Input conductor 2712(1) is connected to comparator 2708(1) of ADC 1054(1).

Assuming the first cycle (e.g., j=0) of implementation 1900 of FIG. 19 for this example, control circuitry 1008 configures ADCs 1054 (2) to apply a gain of eight to MS output signal 1328 to produce MS adjusted signal 1329 and configures 1054(1) to apply a unity gain to LS output signal 1326. Control circuitry 1008 then configures ADC 1054(1) and 1054(2) as shown in FIG. 27 to capture LS output signal 1326 and MS adjusted signal 1329, respectively. FIG. 27 shows an acquisition phase of ADCs 1054(1) and 1054(2) where switches 2702(1) and 2702(2) are closed, switches 2706(1), 2706(2), 2714, and 2716 are open. Capacitors C₀-C₄ of ADC 1054(1) are connected to Vᵢ (e.g., LS output signal 1326), capacitors C₀-C₄ of ADC 1054(2) are connected to Vᵢ (e.g., MS adjusted signal 1329). Accordingly, capacitors C₀-C₄ of ADC 1054(1) are charged from LS output signal 1326 and capacitors C₀-C₁ of ADC 1054(2) are charged from MS adjusted signal 1329. FIG. 28 shows a subsequent conversion phase of ADCs 1054(1) and 1054(2) where switches 2702(1), 2702(2), 2704(1), 2704(2), and 2716 are opened, and switch 2714 is closed. SAR 2710(1) is then controlled to capture ML summing 1914 for the current cycle. During the conversion, SAR 2710(1) synchronized with SAR 2710(2) and both switches 2704(1) and 2704(2) are controlled. Operation of ADCs 1054(1) and 1054(2) in this embodiments is defined by equations (22), (23), (24) and (25), where equations (22) and (23) define the acquisition phase and equations (24) and (25) define the subsequence conversion phase.

$${V}_{i} \cdot 16 C = ( {V}_{R} - {V}_{x} ) {C}_{4} - {V}_{x} ( {C}_{3} + {C}_{2} + {C}_{1} + {C}_{0} ) \qquad ( 22 )$$

$${V}_{x} = \frac{{V}_{R} \cdot 8 C - {V}_{i} \cdot 16 C}{16 C} = \frac{{V}_{R}}{2} - {V}_{i} \qquad ( 23 )$$

$$8 {V}_{i} \cdot 16 C = ( {V}_{R} - {V}_{x} ) {C}_{4} - {V}_{x} ( {C}_{3} + {C}_{2} + {C}_{1} + {C}_{0} ) \qquad ( 24 )$$

### Truncation

In certain embodiments, truncation may be implemented to further reduce propagation of noise. For example, in the embodiments of FIGS. 15 through 22, the two LS-bits of the MS partial sum (e.g., MS partial sum 1116 and MS partial sum 1316) may be truncated during capture by ADCs 1054 or set to zero. As shown in FIGS. 7A and 7B, the ADCs may be controlled to define the number of bits being captured and/or a gain (e.g., V/4) may be applied to the analog signal prior to capture by the ADC to truncate the LS bits.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A noise reduction method for mixed in-memory computing implemented as a cross-bar array of analog cells, where each row of analog cells is connected to one of a plurality of input conductors and each column of analog cells is connected to one of a plurality of output conductors, the cross-bar array performing matrix vector multiplication, the method comprising:
for each row of the cross-bar array:
dividing a digital multiplier into at least a most significant (MS) portion and a least significant (LS) portion, the LS portion having more bits of the digital multiplier than the MS portion;
preloading a first cell of a first column of a first row of the cross-bar array with a first analog signal representative of the MS portion right padded with zeros to have the same number of bits as the LS portion;
preloading a second cell of a second column of the first row of the cross-bar array with a second analog signal representative of the LS portion; and
driving one of the plurality of input conductors of the first row with an analog input signal representing a multi-bit input activation (IA) value for the first row;
capturing an MS partial sum from the first column;
capturing an LS partial sum from the second column;
multiplying the MS partial sum by a scaling factor based on a number of bits in the LS portion; and
adding the LS partial sum and the MS partial sum to form a resulting value.

2. The noise reduction method of claim 1, the LS portion having L LS bits of the digital multiplier, the MS portion being formed of H MS bits of the digital multiplier, and the scaling factor being two raised to the power (L−(L−H)).

3. The noise reduction method of claim 2, the multiplying the MS partial sum comprising left shifting the MS partial sum by (L−(L−H)) bits in a digital domain.

4. The noise reduction method of claim 2, where a number T of bits in the digital multiplier is L+H.

5. The noise reduction method of claim 4, wherein L is five and H is three and T is eight.

6. The noise reduction method of claim 1, wherein the preloading and the driving are performed in an analog domain.

7. The noise reduction method of claim 6, wherein the cross-bar array of analog cells is implemented in a current-domain technology.

8. The noise reduction method of claim 6, wherein the cross-bar array of analog cells is implemented in a charge-domain technology.

9. The noise reduction method of claim 1, the multiplying comprising applying a gain of 2^{(L-(L-H))} to an output signal from the first column in an analog domain prior to capturing the MS partial sum.

10. The noise reduction method of claim 1, the analog input signal being generated to represent the multi-bit IA value corresponding to the row by a digital-to-analog converter.

11. The noise reduction method of claim 1, the dividing the digital multiplier comprising splitting the digital multiplier into the MS portion, the LS portion, and a greatest-significant (GS) portion, and preloading a third cell of a third column of the first row of the cross-bar array of analog cells with a third analog signal representative of the GS portion, the method further comprising:
capturing a GS partial sum from a third output conductor of the third column; and
multiplying the GS partial sum by 2 raised to the power (L+H);
wherein adding the LS partial sum and the MS partial sum comprises adding the LS partial sums, the MS partial sums, and the GS partial sums to form the resulting value.

12. The noise reduction method of claim 1, wherein the cells of the cross-bar array are substantially identical and wherein a bit depth of each cell is configurable.

13. A noise reduction method for mixed in-memory computing implemented as a cross-bar array of analog cells, where each row of analog cells is connected to one of a plurality of input conductors and each column of analog cells is connected to one of a plurality of output conductors, the cross-bar array performing matrix vector multiplication, the method comprising:
for each row of a cross-bar array of analog cells:
dividing a digital multiplier into at least a most significant (MS) portion and a least significant (LS) portion, the LS portion having more bits of the digital multiplier than the MS portion;
preloading a first cell of a first column of a first row of a cross-bar array of analog cells with a first analog signal representative of the MS portion right padded with zeros to have the same number of bits as the LS portion;
preloading a second cell of a second column of the first row of the cross-bar array with a second analog signal representative of the LS portion;
slicing a digital input activation (IA) value of the first row into IA bits; and
for each IA bit:
driving an input conductor of the first row with a first reference voltage when the IA bit is zero and driving the input conductor with a second reference voltage when the IA bit is one;
capturing an MS output signal from the first column as an MS partial sum;
capturing an LS output signal from the second column as an LS partial sum;
multiplying the MS partial sum by a first scaling factor based on a number of bits in the LS portion and a bit position of the IA bit;
multiplying the LS partial sum by a second scaling factor based on the bit position of the IA bit; and
storing the MS partial sum and the LS partial sum in memory of a logic operation unit; and
adding, by the logic operation unit for each IA bit, the LS partial sums and the MS partial sums for each IA bit to form a resulting value.

14. The noise reduction method of claim 13, the LS portion having L LS bits of the digital multiplier, the MS portion being formed of H MS bits of the digital multiplier, and the scaling factor being two raised to the power (L−(L−H)).

15. The noise reduction method of claim 14, the multiplying the MS partial sum by the first scaling factor comprising left shifting the MS partial sum by (L−(L−H)) bits in a digital domain.

16. The noise reduction method of claim 15, where a number T of bits in the digital multiplier is L+H.

17. The noise reduction method of claim 16, wherein T is eight, L is five, and H is three.

18. The noise reduction method of claim 13, wherein the multiplying the MS partial sum by the first scaling factor is implemented by left shifting the MS partial sum in a digital domain.

19. The noise reduction method of claim 13, wherein the multiplying the MS partial sum by the second scaling factor is implemented in an analog domain by applying a gain to the MS output signal prior to capturing the MS partial sum.

20. The noise reduction method of claim 19, wherein the gain is implemented by one or more of a resistive ladder circuit and a switched capacitor circuit.

21. The noise reduction method of claim 13, the dividing the digital multiplier comprising dividing the digital multiplier into the MS portion, the LS portion, and a greatest-significant (GS) portion, and preloading a third cell of a third column of the cross-bar array of analog cells with a third analog signal representing the GS portion, the method further comprising:
capturing a GS partial sum from a third output conductor of the third column; and
multiplying the GS partial sum by a second scaling factor based on a number of bits in each of the MS portion and the LS portion;
wherein adding the LS partial sums and the MS partial sums comprises adding the LS partial sums, the MS partial sums, and the GS partial sums to form the resulting value.

22. A mixed analog/digital in-memory computing system with noise reduction, comprising:
a cross-bar array of analog cells for performing matrix vector multiplication, the cross-bar array having a plurality of input conductors for each row of the cross-bar array, and a plurality of output conductors for each column of the cross-bar array;
an input peripheral circuit for converting, for each row, an input activation (IA) value into an IA analog signal driving the input conductor of the row;
an output peripheral circuit having:
an analog-to-digital conversion circuit for converting, for each column, an output signal carried by the output conductor of the column to a digital value; and
a logic operation unit for multiplying, adding, and storing the digital values from the plurality of columns; and
control circuitry for controlling operation of the input peripheral circuit and the output peripheral circuit to cause the cross-bar array to perform matrix vector multiplication by splitting the digital multiplier between multiple columns and combining digital values from the multiple columns to form a resulting value with reduced noise.

23. The mixed analog/digital in-memory computing system of claim 22, the output peripheral circuit further comprising a variable gain module electrically coupled with the plurality of output conductors to apply at least two different gains to the output signals.

24. The mixed analog/digital in-memory computing system of claim 22, the input peripheral circuit comprising a plurality of word line digital-to-analog converters (DACs).

25. The mixed analog/digital in-memory computing system of claim 22, the output peripheral circuit comprising a plurality of analog-to-digital converters (ADC).

26. The mixed analog/digital in-memory computing system of claim 22, each of the analog cells comprising a memristor, whereby the cross-bar array operates in a current-domain.

27. The mixed analog/digital in-memory computing system of claim 22, each of the analog cells comprising a dynamic random access memory, whereby the cross-bar array operates in a charge-domain.

28. The mixed analog/digital in-memory computing system of claim 22, the cross-bar array, the input peripheral circuit, and the analog-to-digital conversion circuit being implemented on an ASIC die and the logic operation unit and the control circuitry being implemented on a logic die.

29. The mixed analog/digital in-memory computing system of claim 28, further comprising an image sensor communicatively coupled with the ASIC die to provide the IA value, wherein the mixed analog/digital in-memory computing system performs inference on images captured by the image sensor.

30. The mixed analog/digital in-memory computing system of claim 29, each of the analog cells comprising a memristor, whereby the cross-bar array operates in a current-domain.

31. The mixed analog/digital in-memory computing system of claim 29, each of the analog cells comprising a dynamic random access memory, whereby the cross-bar array operates in a charge-domain.

32. The mixed analog/digital in-memory computing system of claim 22, the cross-bar array, the input peripheral circuit, and the output peripheral circuit, and the control circuitry being implemented on a single die.

33. The mixed analog/digital in-memory computing system of claim 32, single die further comprising an image sensor that generates the IA value, wherein the mixed analog/digital in-memory computing system implements inference of images captured by the image sensor.
